(19) United States
(12) Patent Application Publication
(10) Pub. No.: US 2014/0110944 A1
(43) Pub. Date: Apr. 24, 2014

(54) FLAG INSTABILITY FOR DIRECT MECHANICAL POWER GENERATION

(71) Applicants: Morteza Gharib, Altadena, CA (US); Julia Cosse, Pasadena, CA (US); Daegyoum Kim, Pasadena, CA (US)

(72) Inventors: Morteza Gharib, Altadena, CA (US); Julia Cosse, Pasadena, CA (US); Daegyoum Kim, Pasadena, CA (US)

(73) Assignee: CALIFORNIA INSTITUTE OF TECHNOLOGY, Pasadena, CA (US)

(21) Appl. No.: 14/062,509

(22) Filed: Oct. 24, 2013

Related U.S. Application Data
(60) Provisional application No. 61/739,975, filed on Dec. 20, 2012.
(60) Provisional application No. 61/725,809, filed on Nov. 13, 2012.
(60) Provisional application No. 61/718,096, filed on Oct. 24, 2012.

(51) Int. Cl. F03D 5/06; F03B 13/00

(52) U.S. Cl. CPC F03D 5/06; F03B 13/00
USPC 290/54; 416/132 A

(57) ABSTRACT

Flag-type wind and/or water power generation features are described. Fluid-filled embodiments are described. The fluid may be employed for pumping effect and/or dynamic physical property change. Leading-edge and trailing-edge mounted flag architectures are described with various applications including flapping flag arrays and Vertical Axis Wind Turbines (VAWTs).

### RELATED APPLICATIONS

This filing claims the benefit of and priority to US Provisional Patent Application Ser. Nos. 61/718,096, filed Oct. 24, 2012, 61/725,809, filed Nov. 13, 2012, and 61/739,975, filed Dec. 20, 2012, each of which are incorporated by reference herein in their entirety for all purposes.

### FIELD

The embodiments described herein optionally relate to wind and/or water power generation, particularly electrical power generation.

### BACKGROUND

Existing flag-type wind power generation devices are often illustrated as bio-inspired creations. One example of a fluttering “Piezo-tree” employs numerous tabs or flags (or so-called “leafs”), each attached to a PVDF piezo-based stem (or so-called “stalk”) with each such stem/stalk then attached to a support structure. Reciprocal motion of the leaves and stalks driven by vortex shedding behind a bluff body mount produces AC electrical energy. The AC energy is then rectified to DC for storage. See, Li S., Lipson H., (2009), “Vertical-Stalk Flapping-Leaf Generator For Parallel Wind Energy Harvesting,” Proceedings of the ASME/AIAA 2009 Conference on Smart Materials, Adaptive Structures and Intelligent Systems, SMASIS2009; Li, S., Yuan, J., and Lipson, H. (2011), “Ambient wind energy harvesting using cross-flow fluttering,” Journal of Applied Physics, 109, 026104. Another example of a sinuously-moving electric eel is described in Taylor et al., “The Energy Harvesting Eel: A Small Subsurface Ocean/River Power Generator,” IEEE; Journal of Oceanic Engineering (2001) 3; and Deniz Tolga Akcabay and Yin Lu Young, “Hydroelasic response and energy harvesing potential of flexible piezoelectric beams in viscous flow,” Physics of Fluids (2012).

Low conversion efficiencies due to material limitations persist in these piezo-based systems. Likewise, the need for rectifying AC energy (generated by flag oscillation) to DC energy for storage is also inefficient.

More generally, existing flag-type power generation approaches employ a standard or general (trailing) flag setup that only flutters at higher velocities. As such, power cannot be extracted from lower velocity flow.

Therefore, need for improvement exists on a number of fronts. The embodiments described below variously meet these needs and/or others as may be appreciated by those with ordinary skill in the art.

### SUMMARY

In a first flag-type wind power generation architecture, flags are provided with fluid-inclusion means. These means may comprise channels or other configurations as elaborated upon below. In any case, the fluid is contained within a circuit typically including one-way check valve(s). Likewise, the flags are typically self-supporting such that they are able (at least in flow) to hold or support their internal chamber(s) up against the pull of gravity.

In use, motion of the flag in response to viscous flow (e.g., wind or water) pumps fluid within the circuit. Included in a matrix or array of devices, the pumped fluid may be employed to run a generator for electrical power output or maintained for use as mechanical power (converted by means of hydraulics for a given task or directly employed).

The flags in such devices or systems may be employed in a trailing-edge or a leading-edge secured configuration, or at any angle of attack with respect to the free stream between these bounding configurations. With a trade-off of increased design and/or system complexity, the former class of devices (optionally referred to as “inverted” flag designs) may offer significant advantages in terms of cycle amplitude and/or low-flow applications for their motion as compared to so-called standard or general (i.e., leading-edge secured) flag configurations.

A second type of flag-type wind power generation architecture specifically leverages the inverted flag approach with associated advantages. In these embodiments, flag sheets, strips, or panels (alternatively referred to as turbine “blades”) are employed in a Vertical Axis Wind Turbine (VAWT) arrangement that presents each blade to the wind in an inverted flag configuration at some period of time during each rotational cycle. With appropriate flexibility, the inverted flag reaches a critical point in flapping prior to the general flag, creating a boost in force on only one side of the turbine helping drive steady state turbine rotation and/or startup. Following such flapping, the turbine blades reconfigure and create an increase in projected area of the blade on one side of the turbine as compared to the other—again—helping drive steady state turbine rotation.

Each of the above designs are studied by various approaches in an effort to characterize their parameters and behavior. In connection with a simplified beam model, relevant quantities of inverted flag design are characterized in terms of non-dimensional bending stiffness β; in the VAWT example, a related metric, Cauchy number (Ca), is used and employed in a derivation from an existing analytical model to offer comparative estimates of performance. In essence, β and Ca represent similar characteristics but for omission of Poisson's ratio in the case of Ca. Both β and Ca represent a correlation of the material and geometric properties of a particular blade, along with the properties of the surrounding fluid, and hence provide useful alternative system and structural characterizations.

Irrespective of how they are analyzed, described, and/or represented, the flag structures incorporated in the flapping and/or turbine-type architectures may comprise hydro-skeleton constructions offering more control over external forces (e.g., drag) acting thereon. Such hydro-skeleton constructions are structures with an internal chamber. The chamber can be pressurized through a variety of fluids (e.g., air, water, oil, etc.). By changing the pressure of the chamber, the structure will either bend (in the case with dissimilar material properties) and/or change the acting compliance (when the surrounding structure is formed by a compliant material). Such approaches offer useful tools in tuning the physical properties of flag elements in power generation devices, as well as other applications.

### BRIEF DESCRIPTION OF THE DRAWINGS

The figures diagrammatically illustrate various example embodiments. Variations other than those shown in the figures are contemplated as described in a broader sense per the Summary above, as generically claimed, or otherwise.

FIGS. 1A-1D illustrate fluid-filled flag embodiment configurations.

FIG. 2 shows a power generation system example including the FIG. 1B embodiment.

FIG. 3A schematically illustrates an example system for pressure head measurement including the FIG. 1B embodiment; FIG. 3B illustrates an example wind-tunnel setup for the setup in FIG. 3A.

FIG. 4 schematically illustrates another example setup for testing fluid-filled flag embodiment performance employing a stepper motor to generate oscillations as shown in FIG. 5A and a pressure trace as shown in FIG. 5B.

FIGS. 6A and 6B are side and top views, respectively, of a schematic for an example embodiment of an elastic sheet secured in a cantilever fashion.

FIG. 7A plots the Peak-to-peak amplitude A/L of a flag tip and FIG. 7B the Strouhal number fA/U as a function of bending stiffness β for mass ratio of O(1) for H/L=1.3 (squares), H/L=1.1 (circles) and H/L=1.0 (triangles) where in FIG. 7B only the flapping mode with a constant flapping frequency was considered.

FIG. 8 illustrates superimposed flag sheets at four bending stiffness values: (i) β=0.58 (U=2.8 ms⁻¹), (ii) β=0.26 (U=4.2 ms⁻¹), (iii) β=0.10 (U=6.7 ms⁻¹) and (iv) β=0.06 (U=8.5 ms⁻¹) where p=2.9 and H/L=1.1 with Gravity into plane of the drawing in their different modes movement.

FIG. 9 plots the time history of the y-coordinate of the flag tip y(s=L)/L, β=0.26 (solid) and β=0.10 (dashed) where T is a flapping period.

FIG. 10A illustrates modes as in FIG. 8 for several cases of inverted flags (polycarbonate flag of thickness 0.008m and length 30 cm) of height (H) ranging from 1 to 20 inches and wind speed ranging from 2.5 to 6.5 ms⁻¹ where red is in a stable “straight” condition, green is flapping and blue is a re-stabilized deflected position. FIG. 10B charts the wind speed at which a given inverted flag starts flapping (i.e., the flow transition speed between the red and green regions as illustrated in FIG. 10A) as angle of attack to the wind changes.

FIG. 11A plots the hysteresis of amplitude A/L in mode transition showing increasing free-stream velocity (solid) and decreasing free-stream velocity (dashed) where U* represents non-dimensional free-stream velocity and FIG. 11B plots first mode shapes of y/L and θ obtained by proper orthogonal decomposition with β=0.26 (solid) and β=0.10 (dashed) and fundamental mode shape of a linearized Euler-Bernoulli beam (dashed-dot) where θ is the angle between the flag sheet and the −x axis in FIG. 6A/6B and μ=2.9 and H/L=1.1.

FIG. 12A plots Peak-to-peak amplitude A/L of the flag tip and FIG. 12B plots Strouhal number ƒA/U as a function of bending stiffness β for mass ratio of O(10⁻³) for H/L=2.0 (squares), H/L=1.6 (circles) and H/L=1.3 (triangles) where in FIG. 12B only the flapping mode was considered.

FIG. 13A plots drag coefficient (C_{D}), FIG. 13B plots elastic strain energy (E_{S}) and FIG. 13C plots the conversion ratio of fluid kinetic energy to strain energy (R) with mean C_{D} and E_{S} (circle) in bending and flapping mode and maximum C_{D} and E_{S} (square only for the flapping mode, all for mass ration O(1).

FIG. 14 illustrates a sequential vortex formation process (i) to (vi), vorticity contour (β=0.19, μ=0.006) with flag sheet (solid line) at maximum bending at (i) and (v).

FIG. 15 plots Formation Number (F) of the flapping mode for mass ratio O(1) (circle) mass ratio O(10⁻³) (square) where the Formation Numbers for both positive and negative y-sides are averaged.

FIG. 16A is a top view that schematically illustrates an example embodiment of a wind turbine with a flag-type turbine design; FIG. 16B is an annotated version of FIG. 16A.

FIG. 17 illustrates a side view of the turbine configuration of FIGS. 16A and 16B wherein the dashed lines indicate wind tunnel boundary conditions (floor and ceiling) for experimentation as described herein.

FIG. 18 illustrates the subject regimes of flexible flag turbine blade behavior with shaded regions corresponding to shaded regions in FIG. 23. (Note that delineation between regimes does not represent precise boundaries between regimes as boundaries vary in location depending on wind velocity and blade properties.)

FIG. 19A plots average torque in static tests of the example turbine of FIGS. 16A and 16B with rigid flag blades at the pictured positions for 5 ms⁻¹ (squares), 5.9 ms⁻¹ (circles), 6.9 ms⁻¹ (stars), 7.5 ms⁻¹ (diamonds), and 8.5 ms⁻¹ (triangles) wind tunnel speeds. FIG. 19B plots average torque in testing at the wind tunnel speeds for 1/32 inch thick DELRIN flag blades (squares and sum as dashed-dotted line), 1/16 inch thick DELRIN inverted flag blades (diamonds and sum as dotted line), rubber flag blades (circles and sum solid line), and rigid blades (triangles and sum as dashed line).

FIG. 20A plots instantaneous efficiency as a function of angular velocity and FIG. 20B plots the efficiency for one rotation of the turbine as a function of tip-speed ratio for a turbine with the 1/32 inch DELRIN blades.

FIGS. 21A and 21B plot power traces from two different dynamic test loading configurations, each over one period of rotation.

FIGS. 22A-22H are photographs of one rotation period for a dynamic test case;

FIG. 23A plots power repeated rotation of the pictured setup and FIG. 23B details the highlighted portion in FIG. 23A in reference to the pictured states in FIGS. 22A-22H.

FIG. 24 is a flowchart illustrating the cycle of output during one turbine rotation in which inverted flag flapping is experienced.

FIGS. 25A and 25B plot test cases for rigid aluminum and highly-flexible rubber flag blades, respectively (see legends), comparing analytical and test results for torque through one half cycle of turbine rotation.

FIGS. 26A-26C schematically illustrates flag blade deformation predicted by an analytical model for the rubber blades; FIGS. 27A-27C are photographs showing actual deflection under static testing conditions.

FIGS. 28A-28F are photographs demonstrating bending of a flag-type sheet or blade due to internal pressure manipulation.

### DETAILED DESCRIPTION

Various example embodiments are described below. Reference is made to these examples in a non-limiting sense, as it should be noted that they are provided to illustrate more broadly applicable aspects of the devices, systems, and methods described herein. Various changes may be made to these embodiments and equivalents may be substituted without departing from their true spirit and scope. In addition, many modifications may be made to adapt a particular situation, material, composition of matter, process, process act(s) or step(s) to the objective(s), spirit or scope of the present subject matter. All such modifications are intended to be within the scope of the claims made herein.

Fluidic Power Generation Flag

Flapping flag instability has been studied at length. As noted above, several groups have attempted to use this instability to create power with piezoelectric materials. The present embodiments utilize the same instability, but for pumping to generate fluid flow that can then be used to generate power.

A flag with an internal chamber that is placed in a wind stream flaps. While the flag is flapping, it acts as a pump. Through pumping fluid, associated generators are able to convert the fluid flow to electricity. In this way, a simple flag can be imbedded with a chamber and through flapping is able to produce power. Flags can be used in both air and/or water to produce power. The critical factor is having a fluid (i.e., gas or liquid) flow across the flag such that the flapping instability occurs.

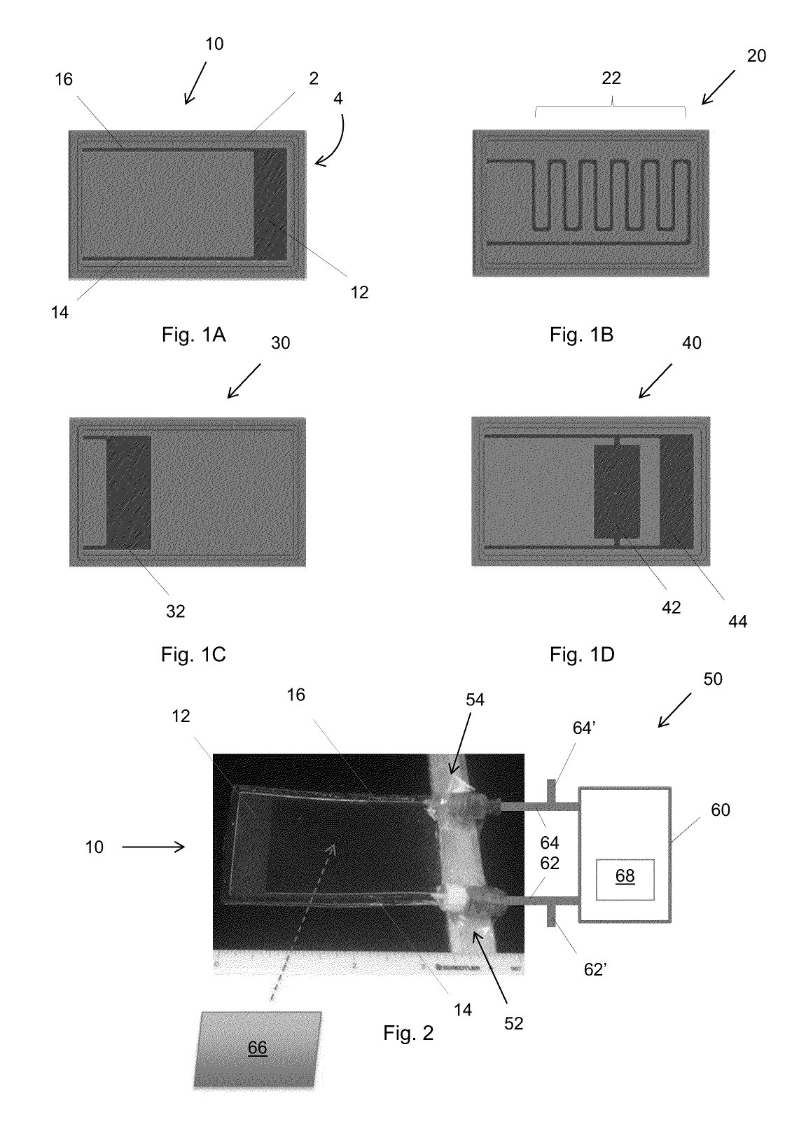

The subject flag can be implemented with chambers that have various geometries. As shown in FIG. 1A, a flag 10 includes a (relatively) large reservoir 12 connected to input and output tubes or channels 14, 16 (respectively). Flag 20 in FIG. 1B includes a series of tubular switchbacks 22. Either type of construction may be referred to as a “chamber” as it is optionally formed as negative or open space between opposing sheet layers 2, 4. The shape and location of the chamber can be otherwise optimized for performance.

Such variability in location includes the placement between the two wall layers (i.e., the chamber(s) may be closer to one wall than the other or the walls on either side of the chamber may have different thicknesses), in which case the neutral axis of the chamber(s) is/are offset. Considered as a cantilever beam, once forces are introduced to different points within the beam, it bends preferably towards one side. Such introduction may be in the form of fluid pressure as described further below.

Also (as alluded to above), configurations can be constructed with single or multiple chambers. Flag examples 30 with chamber 32 in FIG. 1C and flag 40 with chambers 42 and 44 in FIG. 1D represent examples of designs constructed for experiments to that effect. Different flag materials and pumping fluids can be used to improve performance under varying fluid-flow conditions as well.

For a system 50 as illustrated in FIG. 2, in addition to flag format and material (i.e., flag, outside flow, internal fluid), other properties selected to improve performance (e.g., one-way external check valves 52, 54) can be used to force the uni-directional flow for pumping of the internal fluid. Also, improvements to the uni-directional flow can also be provided through the shaping of the internal chamber geometries (e.g., by incorporating one-way valves like those found in biological vasculature). Offset or off-axis placement (e.g., as described above by constructing the flag(s) with different layer material thickness) of the chambers or channels may also be employed to enhance fluid pumping.

Weight from the additional fluid within the internal chambers can aid in reaching the instability threshold that defines when flapping commences. Flag materials can be chosen that enhance the flapping behavior, which in turn will enhance the pumping behavior within the internal chambers. Likewise, the flags can be mounted either behind a “flag pole” (in a so-called conventional, standard or general arrangement) or in front of the flag pole, which can enhance pumping as described below.

Conversion from mechanical to electrical energy can be done either through an embedded or an external converter. An external converter or generator 60 is illustrated in FIG. 2 with input and output lines 62, 64 connected with valves 52, 63. Additional input and output lines 62′, 64′ may be used in employing an array of flags 10, 10′, etc. connected in (a fluidic) parallel arrangement. In addition, it is possible to create a hybrid generator with the addition of photovoltaic overlay layer(s) 66, photoelectric printing employing the flag material as a substrate, by other means, or as a part of the turbine set up.

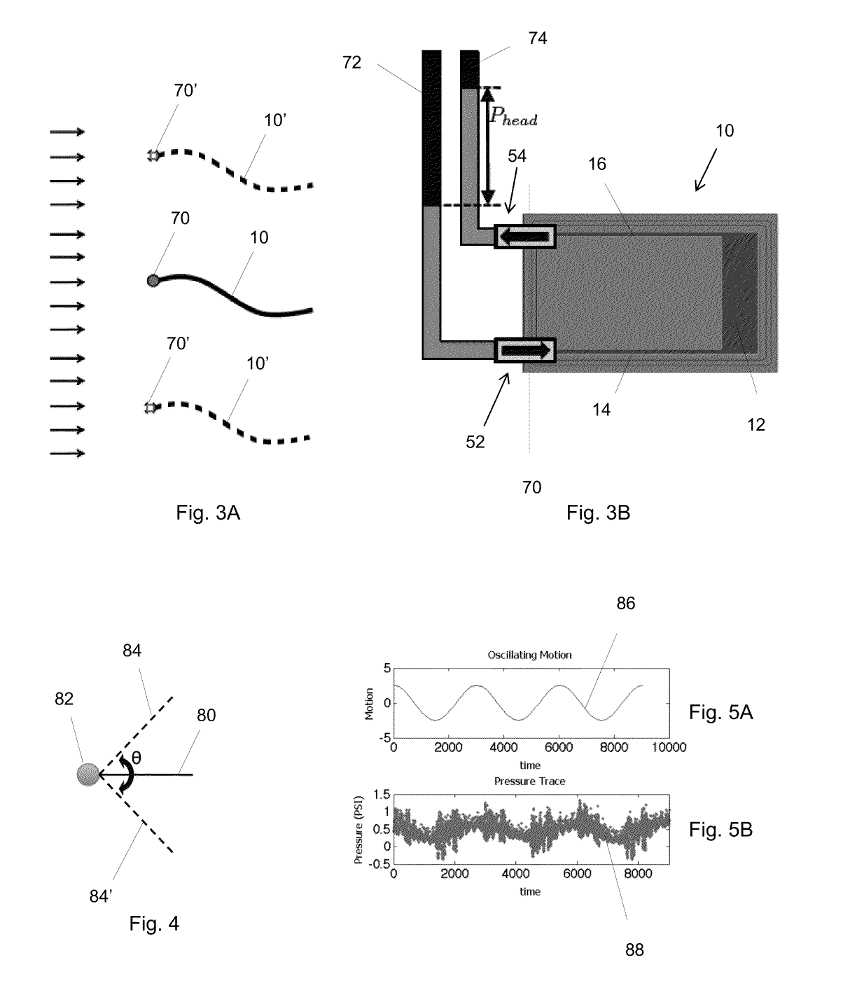

As shown in FIG. 3A, to initially study the architecture, experiments looked at a flag 10 (or 20, 30, etc.) constructed from fused thermoplastic layers (in this case, PDMS material) defining an enclosed chamber and attached to a bar 70 up-stream of air flow (arrows) in a wind tunnel. FIG. 3A also illustrates how an array of such devices may be setup side-by-side (see dashed-line examples 10′, 70′). Alternatively or additionally, multiple flag constructs 10, 10′ may be aligned or stacked in an array vertically along the same pole 70, 70′.

For study, the ends of an internal chamber (e.g., chamber 12 with input and output channels 14, 16) were attached via check valves 52, 54 to vertical tubing 72, 74 as illustrated in FIG. 3B. The chamber with attached tubing was primed with colored water using a syringe. This was done such that the water level was the same in both tubes prior to insertion in wind tunnel flow. With air flow in the tunnel then set to a speed sufficiently high to produce flapping, a pressure head (P_{head}) difference was observed as shown.

The flag constructions shown in FIGS. 1A-1C were tested. While designed to have chamber geometries of identical volumes, the observed pressure head varied greatly between geometries per the Table 1 below:

| Flag # | Pressure Head (psi) |
|---|---|
| 10 | 1.75 |
| 20 | 0.45 |
| 30 | 0.5 |

Thus, the geometry of flag 10 can be considered the most effective at pumping fluid. However, other geometries can also be highly effective.

In another experiment, flags were mounted to a stepper motor. A flag 80 was mounted to a motor shaft 82 to be driven through a specified angle (θ) to bounds 84, 84′ over a defined period (T) as illustrated in FIG. 4. Through the flapping process, the internal pressure of the flag chamber(s) fluctuated. A position trace 86 shown in FIG. 5A was taken where flag 80 was constructed of rigid material and included a chamber with a 2 mm offset from the center axis of the flag. As can be seen in FIG. 5B, the resulting pressure oscillation 88 matches the motion of the stepper motor providing further evidence of the manner in which pumping energy may be extracted from flapping flags in practical fashion, especially in connection with check valves employed to create one-way flow with a consistently positive pressure profile.

Free Leading-Edge and Clamped Trailing Edge Architectures

In the various known methods of extracting energy from flapping flag instability, third-party designs have varied many relevant parameters including the shape of the pole on which the foil is mounted, the weight, size, length, geometry of the foil itself, the media (rivers, oceans, wind) in which the foil is mounted and so forth. However, such examples all involve the situation where the foil is mounted behind a “flag pole” or other mounting device. In other words, the leading edge of the flag has been fixed.

In contrast, certain embodiments hereof fix the trailing edge of the flag, leaving the leading edge free. There are several variations of set-ups that will allow this orientation to function. Large amplitude flapping motion has been demonstrated by the inventors hereof by mounting a thin plastic flag to a rigid stand. The magnitude of the motion demonstrated in suitable setups (as further characterized herein) can produce a higher efficiency conversion of energy from the free stream flow (wind, river, ocean current, etc.) to the mechanical flapping. Also supporting this proposition is that the reversal of the fixed (i.e., clamped or otherwise secured) edge from leading edge to trailing edge allows for flapping at lower fluid flow speeds and, thus, a broader range of applicability. And even at higher speeds, in some instances, the inverted flag may be configured to bend around its mount (180 degrees) and then operate similar to a standard or general flag generator design in which it may flap and continue to produce power.

Inverted flag geometry in power generation can be employed in a number of ways. A first example is in systems as described in the previous section (i.e., as a fluid-pumping flag optionally set in an array) given parameters set forth below. Another example is in a vertical axis wind turbine configuration as detailed in the next section.

Depending on the situation, the flag itself can be rigid or compliant. Tuning maybe accomplished using supplemental torsional spring(s), leaf spring(s), or variation in the material from which the flags are constructed. Also, the selected approach may change the preferred method of energy conversion. Methods of energy conversion include the use of piezoelectric materials, use of an electromagnetic stator/rotor generator, and/or the fluidic approach described above.

The dynamics of an inverted flag (i.e., a flag with a fixed trailing edge) were investigated experimentally in order to characterize the conditions under which self-excited flapping can occur. The flapping dynamics were observed as closely related with periodic formation and shedding of leading-edge vortices.

Inverted flag behavior can be classified into three regimes based on a non-dimensional bending stiffness scaled by flow velocity and flag length. Two quasi-steady regimes were observed (a straight mode, and a fully deflected mode) in addition to a limit-cycle flapping mode with large amplitude that appears between the two quasi-steady regimes. Bi-table states are found in both a straight-to-flapping mode transition and flapping-to-deflected mode transition.

Instead of maintaining a deflected shape at equilibrium, the inverted flag can flap with a large amplitude and store large strain energy because of unsteady drag force. Indeed, a flapping flag sheet can produce elastic strain energy that is several times larger than a sheet in the deformed mode, thereby improving the conversion of fluid kinetic energy to elastic strain energy. Moreover, (quite unlike the instability of the general flag) the effect of mass ratio relative to the magnitude of flag inertia and fluid inertia on the non-dimensional bending stiffness range for flag flapping is negligible.

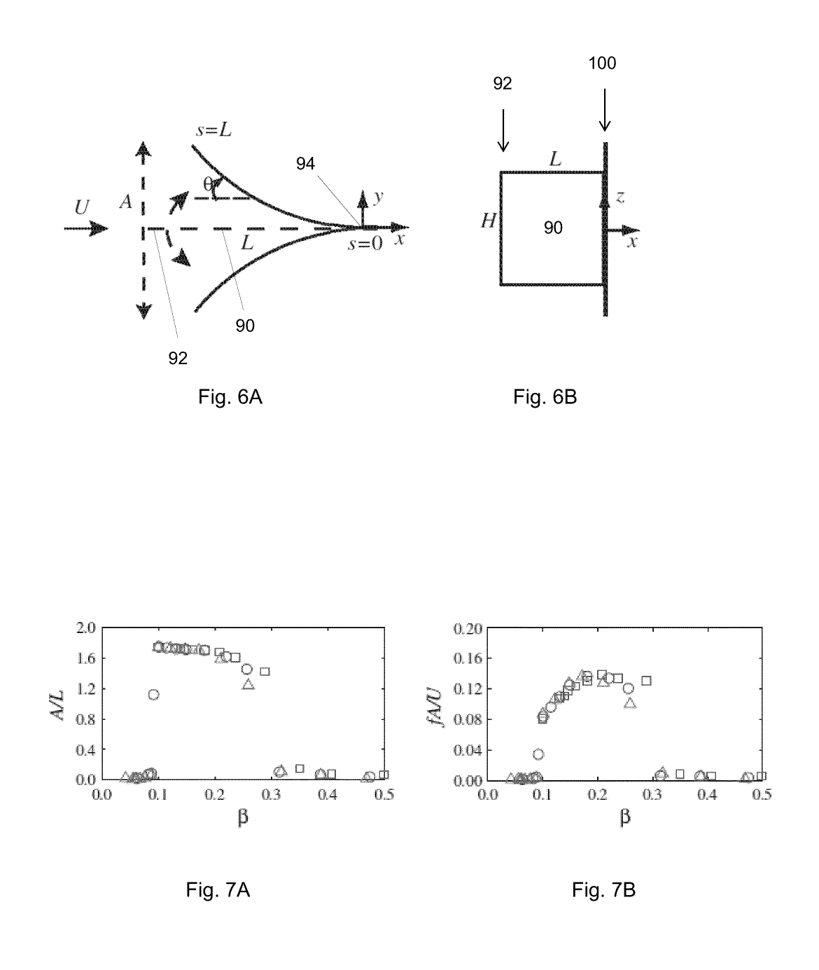

In other words, an inverted flag structure as illustrated in FIGS. 6A and 6B can be configured with high instability to low critical flow velocity while providing high excitation amplitude. Therefore, it offers an excellent opportunity for successful application of flow-induced oscillation to energy harvesting.

As studied in connection with FIGS. 6A and 6B, the dashed line represents the initial state or shape of a flag sheet 90, which oscillates to the curved (solid line) positions. A is the distance between two amplitude peaks of tip 92 in the y-direction and s is a curvilinear coordinate from the rear end mount 100 where flag 90 is secured as a cantilever beam when flag 90 is clamped or otherwise fixed to prevent rotation at 100.

In this example, the flapping dynamics of an inverted elastic flag sheet 90 were investigated in order to characterize how its stability is influenced by parameters such as bending stiffness, flow velocity, fluid density, and sheet length. The effect of the parameters on drag and elastic strain energy was also examined. In addition, the flow structure developed by the sheet was identified, and its relationship with flapping dynamics and strain energy conversion is discussed below.

Experiments were conducted in an open-loop wind tunnel capable of producing free-stream velocity U between 2.2 and 8.5 ms⁻¹. As in FIG. 6A/6B, the downstream edge 94 of flag sheet 90 was clamped vertically between two long aluminum strips 2.5 cm wide and 1.3 cm thick. The plates were made from polycarbonate (Young's modulus E=2.38×10⁹ Nm⁻², Poisson's ratio v=0.38, density ρₛ=1.2×103 kgm⁻³) and sheet thickness (h) was 0.8 mm. The height of the sheet H was fixed at 30 cm, and the lengths of the sheet L were 23 cm, 27 cm and 30 cm, thereby providing aspect ratios H/L between 1.0 and 1.3. The deformation of the sheet occurs primarily in the xy-plane, and the twisting of the sheet due to gravitation was hardly observed. Thus, the deformation was largely two-dimensional. A small tip deflection 0.02<Δ/L<0.04 was observed in the initial sheet configuration due to material defect.

For the observation of sheet motion, white plastic tape was attached along the top edge of the sheet, and its motion was captured by a high speed camera (Nanosense MK3, Dantec Dynamics) mounted over the top of the test section. For each sheet, images were recorded at 100 frames per second as wind speed was increased from 2.2 ms⁻¹ to 8.5 ms⁻¹. The top edge in the images was detected with a MATLAB script (Mathworks, Inc.). Aerodynamic drag D acting on the sheet was measured with two load cells (MBS, Interface, Inc.) connected to the top and bottom of the test section. The drag was also measured with the clamping vertical strips alone and subtracted from the total drag in order to obtain the net drag on the sheet.

As observed, two non-dimensional dynamical parameters are important for the study of interaction between a fluid flow and an elastic sheet. These are the non-dimensional bending stiffness μ and mass ratio μ defined below (Connell & Yue 2007; Alben & Shelley 2008; Michelin et al. 2008):

$$β = \frac{B}{{ρ}_{f} {U}^{2} {L}^{3}} \\ and \\ μ = \frac{{ρ}_{s} h}{{ρ}_{f} L} , \qquad ( 1 )$$

where B is the flexural rigidity of the sheet (B=Eh³/12(1−v²)), ρ_{f} is fluid density and ρₛ is sheet density. The value of β characterizes the relative magnitude of the bending force to the fluid inertial force, and that of μ describes the relative magnitude of solid to fluid inertial forces. In the wind tunnel experiments, β ranged from 0.04 to 1.50, and μ ranged from 2.5 to 3.3.

In order to investigate the effect of mass ratio on flapping dynamics, experiments were also conducted in water for low mass ratio of O(10⁻³). Flag sheets were clamped vertically in a free-surface water tunnel with a test section 1.0 m wide and 0.5 m high and a camera (IGV-B1920, Imperx, Inc.) was mounted below the floor of the test section, with images of the bottom edge of the sheet were recorded at 10 frames per second as the water speed increased. The water velocity ranged between 0.15 and 0.53 ms⁻¹. Polycarbonate flag sheets at 0.8 mm thick were tested at 15 cm, 19 cm, and 23 cm lengths. While μranged from 0.05 to 1.38, p was several orders of magnitude lower than that of the wind tunnel experiments, ranging from 0.004 to 0.006.

In addition to capturing images of the sheet, planar digital particle image velocimetry was performed in the water tunnel to visualize vortical structures of the flapping flag sheet. For this purpose, the tunnel was seeded with silver-coated hollow ceramic spheres of 70 μm (AG-SL150-16-TRD, Potters Industries). The particles were illuminated by an Nd:YAG laser sheet (Gemini PIV, New Wave) at the middle height of the flag sheet. Image pairs were captured at a rate of 15 pairs per second, and processed with PIVview (PIVTEC GmbH). Each pair of the images was cross-correlated with a multi-grid interrogation scheme. The first interrogation window size was 128×128 pixels with a 50% overlap, and the final window size was 32×32 pixels with a 50% overlap, which produces 119×66 grids with the size of 5.8 mm.

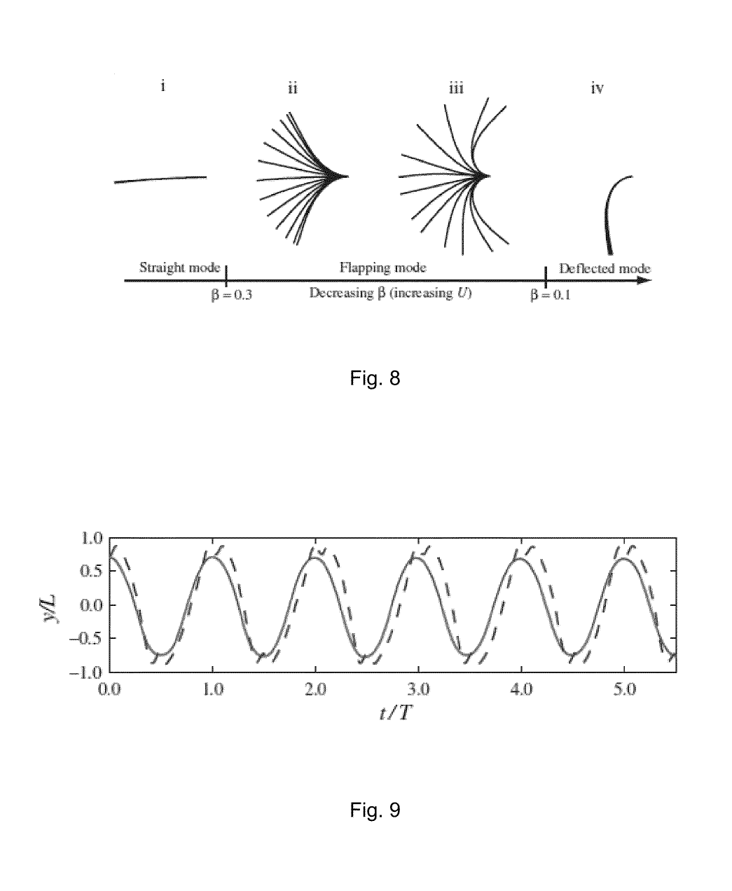

As for results of such testing, amplitude and flapping frequency of the elastic flag sheets are presented for high mass ratio of O(1). The responses of the sheet are divided largely into three modes, depending on non-dimensional bending stiffness β. FIGS. 7A and 7B plot and FIG. 8 illustrates these results.

For β higher than 0.3, the flag sheet remained in a straight (mode (i), FIG. 8). For β lower than 0.1, the flag sheet bent in one direction and maintained a highly curved shape (mode (iv), FIG. 8). Even though the sheet fluttered slightly in both Straight mode (i) and Deflected mode (ii), the peak-to-peak amplitude of the tip A/L is less than 0.2 in these two modes and flutter periodicity was not clear. Between these two quasi-static modes (0.1<β<0.3), the flag sheet flapped side to side, and the deflection of the sheet was periodic with nearly constant A/L (modes (ii), (iii), FIG. 8). A/L increased drastically in the flapping mode, and plateaued to a range between 1.7 to 1.8. In 0.1<β<0.2, the sheet continued to bend past when the tip is at maximum |y|, which resulted in slight decrease in the |y|-position of the tip at maximum deformation as described in FIG. 8 mode (iii) and FIG. 9. Within the flapping regime, unlike A/L (see FIG. 7A), the Strouhal number did not show a plateau but has a maximum value of 0.14 around β=0.2 (see FIG. 7B).

Thus, inverted flag designs show several characteristics distinct from those of a general or standard flag with a clamped or pinned leading edge and a free trailing edge. An inverted flag is able exhibit larger peak-to-peak amplitude (e.g., up to A/L=1.7 to 1.8 or about 2) than the general flag. The large amplitude is realized because the aerodynamic force on the sheet.

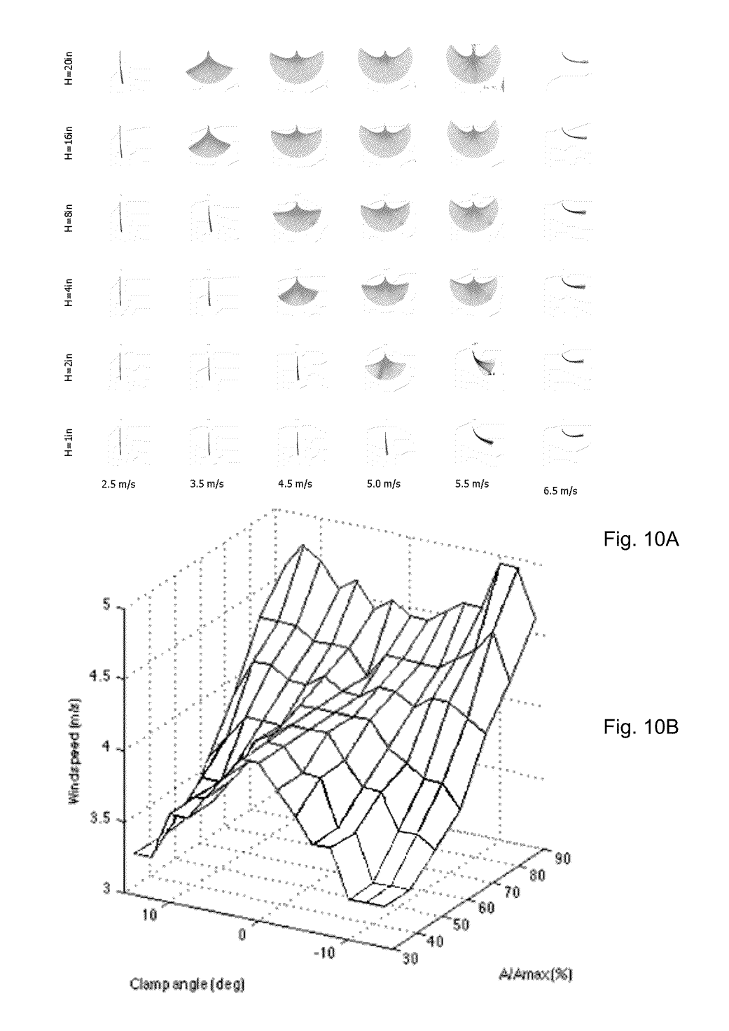

Lift or drag destabilize the sheet from the initial “straight” position. Lift and drag act to destabilize the flag when moving—as shown in FIG. 10A for several cases of flags of a height (H) ranging from 1 to 20 inches and wind speed ranging from 2.5 to 6.5 ms⁻¹ from the red (higher beta) to the green (mid range beta, where flapping is demonstrated). Drag increases with increasing velocity. At some point, this acts to “restabilize” the flag sheet in some sort of reconfigured shape as shown in the blue region in FIG. 10A.

While FIG. 10A considers the flags set parallel to the flow, FIG. 10B graphs the wind speed at which a flag starts flapping (i.e., the transition speed between the red and green regions shown in FIG. 10A) considering angle of attack to the wind. In FIG. 10B, a clamp angle of zero corresponds to the flag being aligned parallel to the flow. Because drag effects are more important when the flag is not perfectly parallel to the free stream than when the flag is parallel, a few things happen. First, the flag starts flapping earlier—however this flapping is of a smaller amplitude that the phenomenon seen when there is no angle of attack. In order to look at this more fully the percentage of amplitude/maximum amplitude flapping was changed at which the flag is considered to have fully reached the flapping state. This is what the third axis (A/Amax) in the figure shows. So if the flag is flapping at 30% (a value from which energy can be extracted therefrom) then if the flag is clamped at an angle it may flap sooner than it would otherwise (i.e., up to a point). Second, if the angle of attack is too large, the flag will not flap and will bend back (similar to the last row in FIG. 10A when the flag goes from the red to the blue configurations immediately without transitioning through the large amplitude flapping region). Third, if full flapping is considered to be very large amplitude (e.g., 90% of max) it takes a higher flow velocity than that of the flag parallel to the fluid flow.

Generally speaking, one will find that an inverted flag will be able to flap at lower velocities than a flag in a general or standard arrangement. However as can be seen that it is possible (depending on the flag type and geometry) to completely miss entering an inverted flapping region. In other words, while the general flag exhibits periodic or chaotic flapping motion beyond a single critical bending stiffness, the inverted flag experiences large-amplitude oscillation only within a specific range of the bending stiffness.

On the other hand, an inverted flag with very small bending stiffness beyond the bending stiffness range studied here may behave differently. The very flexible sheet may bend around the clamped trailing edge and become parallel to the free stream, which results in the configuration similar to the general flag.

Subcritical bifurcation and bistable states are found in the inverted flag (see FIG. 11A). Bistable states exist in both straight-flapping mode transition and flapping-deflected mode transition. In increasing non-dimensional free-stream velocity U*=√1/β=√ρ_{f}L³/B, the critical velocities U*_{c} are 2.1 in the straight-flapping mode bifurcation and 3.4 in the flapping-deflected mode bifurcation for the sheet of μ=2.9 and H/L=1.1. Then, when U* decreases from the deflected mode, the flag sheet tends to maintain its deformed shape and eventually has a slightly lower U* (=3.3) than U*_{c} of the increasing velocity. From the flapping to the straight mode, the initial condition of periodic flapping causes U*_{c} (=2.0) to be also lower than U*_{c} of the increasing velocity. The U* widths of the two hysteresis loops are 0.1, and the corresponding dimensional wind velocity ranges in the hysteresis loops are about 0.3 ms⁻¹. In spite of small width of the bistable region, the hysteresis was exhibited consistently in both transitions for every test.

Mode shapes of the flapping sheet were obtained by Proper Orthogonal Decomposition (POD) with the time series of the flag position data (Berkooz, Holmes & Lumley 1993). The y-coordinate of the sheet is decomposed with orthogonal modes φₖ(s) as y(s, t)=Σaₖ(t)φₖ(s) in the curvilinear coordinate s and time t. The first POD mode φ₁(s) with the largest eigenvalue is dominant at which the amplitude of the sheet increases monotonically from the root to the tip (FIG. 11B). The root mean square error of the y-coordinate approximated only by the first mode was within 1.5% of the flag sheet length over a cycle; the error increased generally as the sheet underwent large deformation such as in β=0.1. In β=0.26 with relatively low peak-to-peak amplitude (FIG. 8, mode (ii)), the POD mode is similar to the fundamental mode of the linearized Euler-Bernoulli beam equation, ρₛh∂t²y+B∂ₓ⁴y=0 with free leading-edge and clamped trailing-edge boundary conditions. When the amplitude saturates with decreasing β, the POD mode deviates from the fundamental mode, and the mode shape becomes more flattened. The dominance of the first POD mode in the decoupling of spatial and temporal components of y(s,t) clearly shows that the oscillation of the flag sheet is in a stationary wave form instead of a traveling wave observed in the general or standard (i.e., non-inverted) flag.

The first POD mode of the orientation angle θ, the angle between the inverted flag sheet and the −x axis at a given s/L (see, FIG. 6A), is also presented in FIG. 11B. The value of θ increases linearly from the clamped trailing edge, but the slope of θ (curvature) reduces gradually along s and reaches to zero at the tip. In contrast to the mode shape of y, the mode shapes of θ are almost identical in the flapping mode regardless of bending stiffness β.

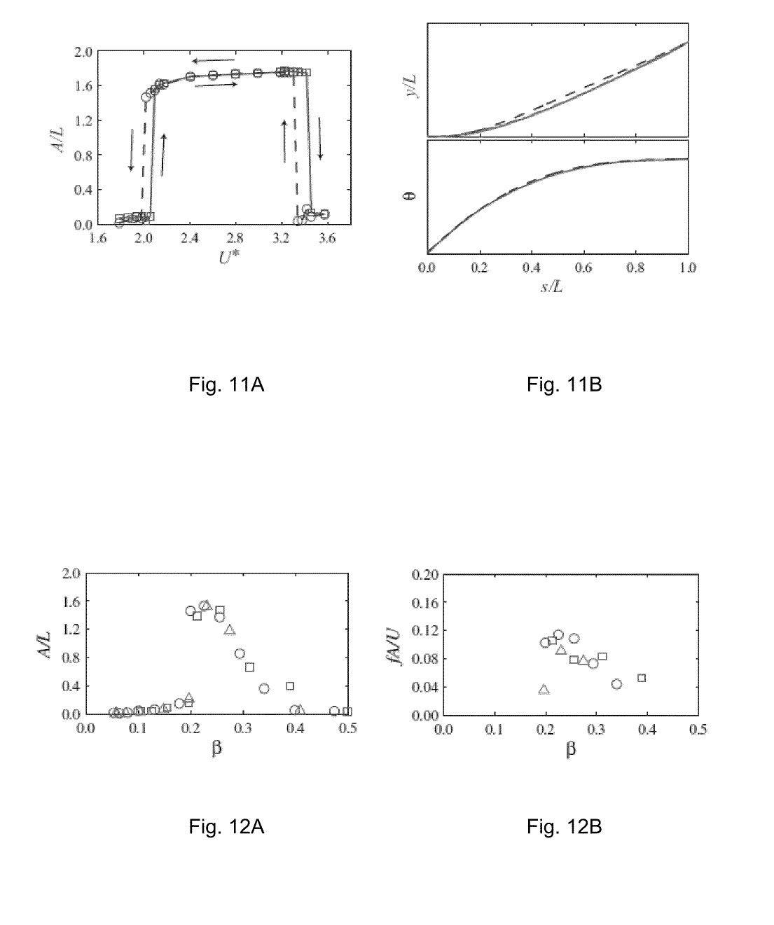

In low mass ratio of O(10⁻³), the flag sheet can also flap with A/L>0.2 in the range of 0.2<β<0.4 (FIGS. 12A and 12B), which is similar to the flapping range of the high mass ratio (FIGS. 7A and 7B). However, due to high fluid density and resultant high added-mass effects, the oscillation of A/L>1 occurs in a smaller range of β, 0.2<β<0.25. In many cases of the flapping mode, the flag sheet does not cross the y=0 line after rebounding, but repeats to bend and rebound in one y-side only so both maximum and minimum y have the same sign. (Notably, this can occur in air as well, see example in FIG. 10 for 2 inch at 5.5 ms⁻¹ how the flag flaps only to one side.) For this reason (in the O(10⁻³) case), both A/L and fA/U decrease from those of high mass ratio (i.e., when comparing FIGS. 7A/7B against FIGS. 12A/12B).

The periodic flapping in the low mass ratio is one of the interesting features of the inverted flag. In the general flag, the critical bending stiffness is nearly linear with μ for μ<1, and less than 10⁻⁴ at p=10⁻³. However, in the inverted flag, the bending stiffness range of the flapping mode is not significantly changed by the mass ratio between O(1) and O(10⁻³). Only dynamical behaviors such as amplitude and flapping frequency are significantly affected.

In that the inertia effects of the sheet and the surrounding fluid are negligible, static divergence instability rather than flutter instability should be responsible for the unstable motion of the straight sheet. As the lift force exceeds the restoring bending force in decreasing β, the straight sheet starts to bend in one side by buckling and unsteady flows eventually induces limit-cycle flapping as a post-divergence behavior.

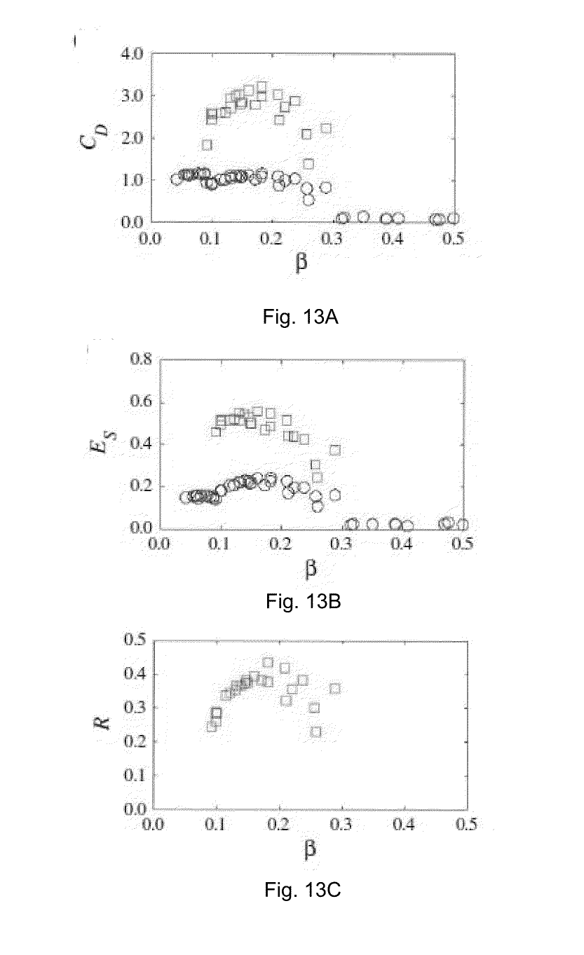

Once the sheet starts to deflect with high amplitude, the drag exerted on the sheet becomes a major source for bending. In this case, the dependence of aerodynamic drag and elastic strain energy on the dynamical modes may be examined. Only the cases of high mass-ratio O(1) are considered below. Drag coefficient C_{D} and non-dimensional elastic strain energy E_{S} are defined as follows:

$${C}_{D} ( t ) = \frac{D ( t )}{\frac{1}{2} {ρ}_{f} {U}^{2} HL} \\ and \\ {E}_{S} ( t ) = \frac{{\int }_{0}^{L} \frac{1}{2} {BK ( s , t )}^{2} d s}{{ρ}_{f} {U}^{2} {L}^{2}} = {\int }_{0}^{1} \frac{1}{2} β {κ ( s , t )}^{2} d ( s / L ) , \qquad ( 2 )$$

where K(s,t) is a dimensional curvature at a given curvilinear coordinate s and K=KL. Since fA/U is 0.1 to 0.2 in the flapping mode, unsteady transient force should not be neglected, especially when the sheet is in a high angle of attack against the free stream. Thus, the max C_{D} of the flapping mode, which occurs when the tip reaches at max |y|, is two to three times higher than the mean C_{D} of the deflected mode (see FIG. 13A). Furthermore, although the sheet bends and relaxes repeatedly, the mean C_{D} of a cycle in the flapping mode is comparable to that of the deflected mode.

The curvature K of the clamped trailing edge at a maximally deformed phase increases from 4 up to 7 to 8 as β decreases from 0.3 to 0.1 in the flapping mode. Meanwhile, K of the trailing edge is between 5 and 8 in the deflected mode. Because of high curvature comparable to the deflected mode, the max E_{S} of the flapping mode≈0.40 to 0.60 is much larger than the mean E_{S} of the deflected mode≈0.15 (see FIG. 13B). As demonstrated comparing modes (iii) and (iv) in FIG. 8, despite lower wind velocity, an elastic flag sheet of the flapping mode can bend downstream more and have higher dimensional strain energy than a sheet of the deflected mode. Moreover, the flapping mode generates the mean E_{S} of a cycle higher than that of the deflected mode.

The total kinetic energy of the incoming flow gassing through the maximum frontal area during a bending phase is

$${\hat{E}}_{K}^{d} = \frac{1}{2} {ρ}_{f} {U}^{3} \vert \hat{y} \vert H \hat{T} .$$

And |ŷ|H is the maximum frontal area of the flag sheet during bending in either positive or negative y-side. \hat{T} is the time from when the tip of the sheet crosses the y=0 line to when the sheet is at maximum deformation. From (2), the conversion ratio from fluid kinetic energy to strain energy during bending is defined as:

$$R = \frac{{\hat{E}}_{S}^{d}}{{\hat{E}}_{K}^{d}} = \frac{{\int }_{0}^{L} \frac{1}{2} B {\hat{K}}^{2} d s}{\frac{1}{2} {ρ}_{f} {U}^{3} \vert \hat{y} \vert \hat{T}} , \qquad ( 3 )$$

where Ê_{S}^{d} is the dimensional strain energy at maximum deformation. The conversion ratio R is between 0.2 and 0.4 in the bending phase of the flapping mode, and has a peak value near β=0.17 to 0.20 (see FIG. 13C). Here, R indicates how much the elastic strain energy can be stored from fluid kinetic energy flux for the possible energy transfer to other dissipative energy forms (e.g., fluid pumping and electrical conversion per above, for piezo-based conversion, etc.).

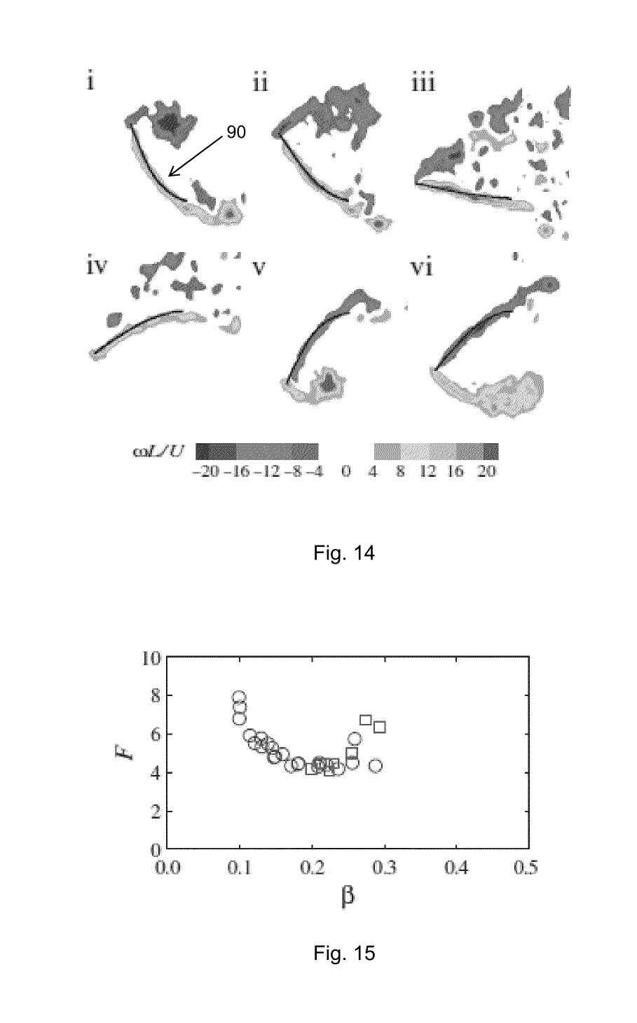

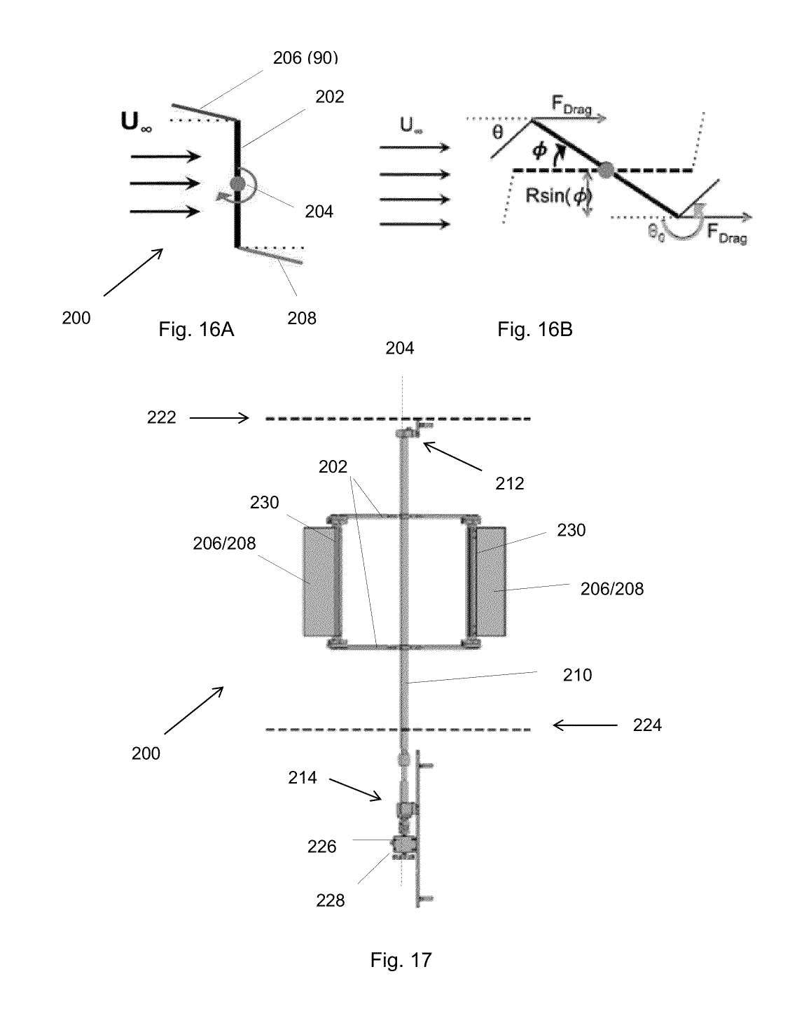

Regarding the underlying physics, fluid flow visualization shows strong correlation between the development of vortex structures and the flapping dynamics of the inverted flag sheet (see FIG. 14). After the sheet 90 crosses the y=0 line, a vortex starts to form at the leading edge. The leading-edge vortex continues to grow as the sheet bends (i) to (ii), and separates from the leading edge (iii) and moves downstream (iv) as the sheet rebounds and repeats on opposite side (v) to (vi). As a result, alternately signed leading-edge vortices shed periodically into the wake in response to the flapping frequency of the sheet. And (per above) even though the visualization in the water tunnel was only performed in this study for the low mass ratio O(10⁻³), it is reasonable to infer that the flapping of the sheet and the shedding of the leading-edge vortices in the high mass ratio O(1) will also be synchronized.

Thus, the strain energy is stored while the leading-edge vortex is being developed during bending and reaches maximum when the vortex is fully developed. The strain energy is released when the vortex starts to separate from the leading edge and the sheet rebounds. From this observation, how optimal leading-edge vortex formation process is related with the magnitude of strain energy conversion may be studied.

For this purpose, the concept of Formation number is employed. The formation number was first suggested in Gharib, M., Rambod, E. & Shariff, K. 1998, “A universal time scale for vortex ring formation,” J. Fluid Mech. 360, 121-140. For present purposes, Formation Number (F) is defined as:

$$F = {\int }_{{t}_{i}}^{{t}_{f}} \frac{U + {u}_{x} ( t )}{\vert \tilde{y} \vert} d t . \qquad ( 4 )$$

In the present system, t=tᵢ is when the tip crosses the y=0 line, t=t_{f} is when the flag sheet is at maximum deformation, |\tilde{y}| is the y-coordinate magnitude of the tip at t=t_{f} and uₓ(t) is the x-directional velocity of the tip. The growth rate of the vortex strength is reduced by the downstream motion uₓ of the flag sheet with a magnitude that can be up to 0.6 U. Therefore, uₓ(t) is included in the definition of F.

In both low and high mass ratios, the formation number F of most flapping cases is within a narrow range between 4.0 and 6.0 even though the flapping dynamics are different among various conditions of β and μ (see FIG. 15). The F curve shown as a function of β is in a concave shape and has a trough around β=0.2. It is found that F is in the range of 4.0 to 4.5 at β=1.7 to 2.0 where the energy conversion ratio is high (FIG. 13C).

Notably, this number is close to the formation number for efficient performance of powered systems such as jet propulsion. The subject analysis further suggests that the formation number may also be used as a parameter to characterize the relation between optimal vortex formation and efficient storage of strain energy during bending in the self-excited flapping system.

Vertical Axis Flag Turbine

Historically, wind energy was first captured using vertical axis wind turbines (VAWTs). While striving for higher conversion efficiencies, VAWT technologies were abandoned in favor of horizontal axis wind turbines (HAWTs) at the cost of simplicity and durability. Meanwhile, VAWT farms are proving to generate more energy per unit land area than HAWTs due to spacing requirements. In this section, features are described suited to offer improve durability and elegance in VAWT design.

A VAWT turbine was built and tested with both rigid and compliant blades. The model was unable to sustain rotation when it was equipped with rigid blades. In contrast, when the model was equipped with compliant blades the turbine not only demonstrated remarkable self-starting capabilities but also produced power in connection with the type of inverted flag instability and reconfiguration discussed and demonstrated above.

VAWTs have several benefits compared to the modern horizontal axis wind turbines (HAWTs) including directional independence from the wind, easier maintenance, reduced noise and visual signatures and ability to achieve closer spacing resulting in increased power density. These benefits are caused by the way VAWTs differ from their horizontal counterparts.

HAWTs are directionally independent from the wind. While this is typically viewed as a positive trait, the turbines have no mechanism by which they may turn out of the wind (like HAWTs) to prevent damage in high wind conditions. Designs to mitigate damages would be advantageous. Directional independence also necessitates a tricky design where the blades of a VAWT have higher forces on one side of the turbine in comparison to the other—in other words, a force differential or asymmetry across the turbine is required for operation. Stated otherwise, for VAWTs in use, one side of the turbine is moving upstream in the wind and one side is moving downstream. Fundamentally, VAWTs spin due to a drag differential across the opposite sides of the turbine. As such, blade design is critical in determining VAWT performance.

This work explores using the mechanism of flexibility and associated (part-time) inverted flag dynamics (for flapping and/or reconfiguration) as well as general flapping flag type instability as pertinent to the issues of design durability and/or enhanced force differential across a wind turbine.

In these designs, flexible blade react to forces (such as from wind) differently than rigid blades. For example, rigid blades will have a drag force that is always proportional to the square of velocity. However, the flexible blades can both enhance the drag force as well as diminish the drag force. They can be in predetermined configurations to improve performance (either actively or passively). They can naturally or artificially flap or oscillate to help propel the turbine going with or against the wind.

In one aspect, the blades are able to reconfigure in response to high wind as per an example of a leaf that flips back and over, or more technically such as shown in mode/configuration (iv) in FIG. 8 and beyond to a trailing free edge configuration. In another aspect, the VAWT includes at least one pair of flag type panels or sheets operating in accordance with aspects described above and as further elaborated upon below.

To characterize such performance, a flag-type VAWT model was built such that blades of different materials could easily be interchanged and the blade pitch angle set as desired. The turbine was studied experimentally under two conditions. In the first (hereafter referred to as “static testing”), the turbine was prevented from rotating via a clamping mechanism. The clamping mechanism was constructed such that the turbine could be clamped at several different angles relative to the free-stream flow. In the second condition, (hereafter referred to as “dynamic testing”), the turbine was free to rotate. A motor was applied in the opposite direction of the turbine's rotation in order to adjust the turbine's power output. In both situations, images of the blade behavior were recorded and analyzed in conjunction with the torque (in the case of static testing) or power (in the case of dynamic testing) data.

Experimental results from static tests show the flexible flag-type blades enhance the torque differential experienced across the turbine. Experimental results from dynamic tests show the turbine was unable to rotate when otherwise identically-configured rigid blades were affixed to the turbine.

With the flexible blades, different modes of blade behavior resulted in turbine rotation. In addition, the turbine affixed with flexible blades was able to self-start from rest when wind velocity was raised. Analytical work was performed to help explain how the various modes of blade behavior observed aided in turbine rotation. The characteristics of the flexible blades are described in detail along with an analysis of turbine performance.

A small scale VAWT was built and installed in a wind tunnel. Viewed from above, the turbine was configured as shown in FIG. 16A. Specifically, turbine 200 includes support arm(s) 202 turning on an axis 204. The supports secure flag type sheets (alternatively referred to as panels or blades in this section) 206, 208 opposite one another. As the turbine turns between the states shown in FIGS. 16A and 16B, upper blade 206, oriented as an inverted flag (90), bends (either passively or actively) such that it experiences higher forces than lower blade 208, oriented as a standard or general flag, that also bends (again, actively or passively) such that it experiences lower forces. FIG. 16B further annotates the same structure in which α is the angle of attack of the blades, θ is the angle of the turbine's rotation and φ is defined as the angle of attack of the blades to the free stream U_{∞}.

In greater detail, FIG. 16 illustrates the turbine as-built, including a vertical shaft 210 held between two bearings 212, 214 and secured in a wind tunnel 220. The top bearing 212 was secured to the top 222 of the wind tunnel and the shaft passed through the floor 224 of the wind tunnel where it connected to the bottom bearing 214. The lower end of the shaft passed through the bottom bearing to connect to one side of a Futek TRS605 torque meter and encoder 226 (alternatively representing/represented by a generator). The second side of the torque meter and encoder system was connected to either a clamp 228 or a load depending on the experiment as further described below.

The support arms 202 were attached to shaft 210 at 180° apart. Between them, blades 206 and 208 were secured between two optical anglers 230 such that the blade angle (β) could be accurately set for each blade.

Different blade materials were selected to illustrate behavioral differences between blades of contrasting compliances per Table 2 below:

| | Young's Modulus | | Thickness | | Ca |
|---|---|---|---|---|---|
| Material | (E) | | (t) | | U_{∞} = 8:5 m/s |
| Aluminum | 69 | GPa | 0.003175 | m | 0.005 |
| | | | (⅛ | inch) | |
| DELRIN | 2.4 | GPa | 0.0015875 | m | 1.13 |
| | | | ( 1/16 | inch) | |
| DELRIN | 2.4 | GPa | 0.00079375 | m | 9.04 |
| | | | ( 1/32 | inch) | |
| Rubber | 2 | MPa | 0.003175 | m | 157 |
| | | | (⅛ | inch) | |

The blades were mounted between arms 202 at a distance of 9 inches from vertical shaft 210. Wind speeds in the tunnel 220 were varied between 5 and 8.5 ms⁻¹.

For static testing, the turbine was fixed at various angles of rotation in order to focus on the force differential between the upstream and downstream blades given the different parameters involved. The lower side of torque meter and encoder was clamped to prevent rotation of the turbine while allowing for the data collection of the torque differential (τ_{c}) at each of the fixed angles. The torque differential is described by:

τ_{c}=(F_{U}−F_{D})R sin φ (5)

where F_{U} and F_{D} are the forces acting on the upstream and downstream blades respectively, R is the length of the moment arm and the sin φ term is a geometric artifact stemming from the changing turbine angle relative to the free stream (U_{∞}).

Static testing was performed on each blade type at 15 different angles every 24° around a full 360° turbine rotation. Measurements were consolidated through superposition to every 12° over half of the full rotation (e.g., data taken at a static angle of 192° is displayed at 12°). In addition to the torque data, a high speed camera was mounted above the tunnel and recorded images of the blades at a rate of 100 frames/second during each of the experimental runs. These images enabled an analysis of the blade deformation observed in tests with the compliant blades.

Dynamic tests were performed in which the lower side of the torque meter and encoder was connected to a DC motor mimicking the load a generator would apply on a turbine. The load was varied by discrete increments between the freely rotating situation with no load (T=0) to the point where the load was sufficiently high to prevent turbine rotation (φ=0). This load variation technique established the power curve and pinpointed the regime where the turbine operated most efficiently.

Torque and angular velocity data were collected for every load case after the turbine was allowed to reach steady state operating conditions. Turbine efficiency, as defined in equation 6, was calculated and compared for each test.

$$η = \frac{τ \dot{φ}}{\frac{1}{2} {ρ}_{air} {A}_{swept} {U}_{∞}^{3}} \qquad ( 6 )$$

Tip-speed ratio, defined as the velocity ratios between the blade tip as compared to the flow speed is described in equation 7.

$$λ = \frac{2 π R \dot{φ}}{{U}_{∞}} \qquad ( 7 )$$

Power curves expressing efficiency as a function of tip speed ratio were made for both instantaneous values of torque and angular velocity as well as values averaged over individual rotations.

In both static and dynamic tests, blade behavior was observed through a high speed camera mounted above the wind tunnel. In the case of the rigid aluminum blades, no dynamic behavior was observed. However, in the case of the flexible blades several types of behavior—flutter, reconfiguration and divergence—were observed. The specific type of behavior depended primarily on blade type and angle of attack.

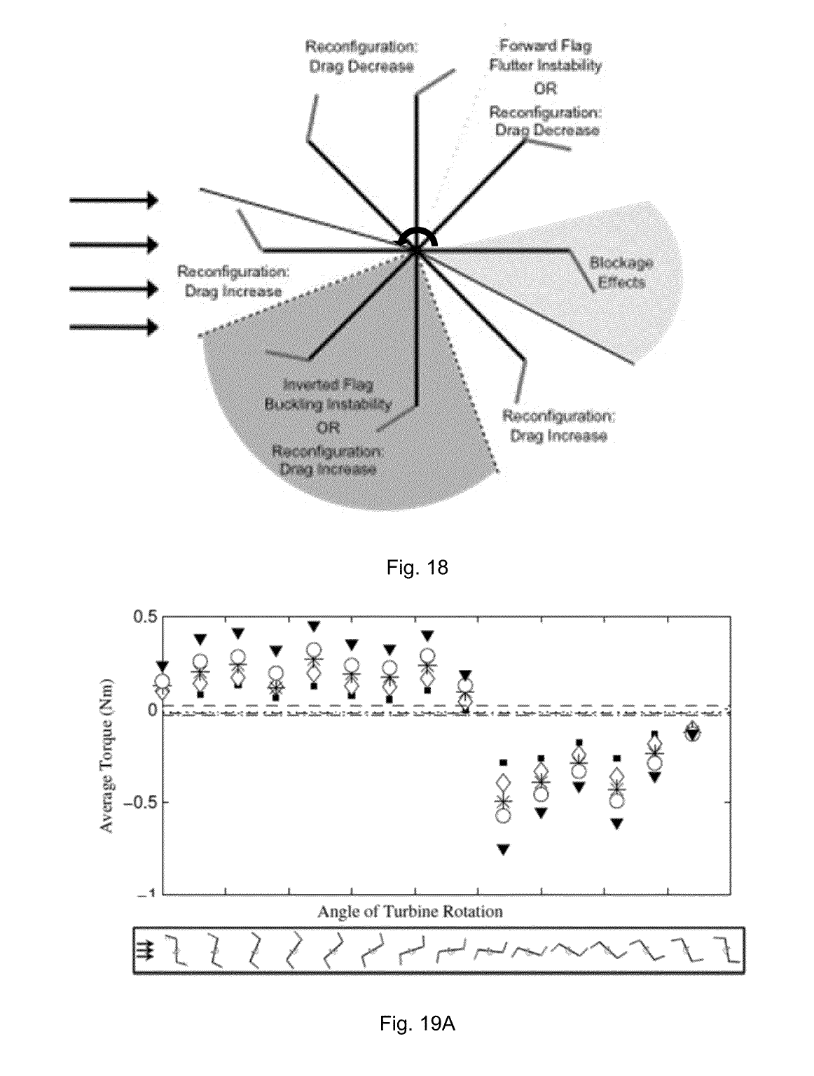

These regimes are presented in FIG. 18. And while FIG. 18 delineates these regimes, their exact boundaries are neither constant across blade types nor across wind speeds. Nor does every regime of behavior exist under all conditions studied; further discussion is provided below.

Regarding the static testing, FIG. 19A shows static torque data for the turbine with rigid blades at several points around the turbine's rotation. The horizontal lines represent the average torque values across the full turbine rotation. The average torque for the turbine with rigid blades is near-zero for each set of velocity measurement, indicating that the turbine will not be able to sustain rotation during dynamic testing in this case. Stated otherwise, while the magnitude of torque increases with increased velocity there is no qualitative difference in the averages.

Notably, the same qualitative similarities were found for all turbine setups, therefore all further comparisons between turbine types will be made at a free-stream velocity of 8.5 ms⁻¹. Also notable is the fact that when the upstream blade passes the downstream blade (effectively blocking the downstream blade from the wind, shortly after 90°) the turbine produces back-torque regardless of which blades are in use. While this is not desirable and would reduce the speed of rotation during regular operation this trend is quite common in VAWTs.

What is most interesting to note is that in comparing the results in FIG. 19A vs. those in FIG. 19B (presenting flexible-blade data) is that when the turbine exhibits positive torque, the flexible blades greatly enhance the magnitude of torque exerted on the turbine. Moreover, in the situations where the turbine is producing back-torque, the flexible blades also reduce the negative impact and in some situations even create a positive (albeit low) torque in comparison to the turbine with rigid blades. Accordingly, examples of the flexible blade turbine have a positive average torque, indicating that the turbine will sustain rotation, even with a few moments of back-torque.

The shaded coding is also interesting to observe in FIG. 19B. Specifically, the graph is gray-scale coded to match the graphic in FIG. 18. Turbine rotation in the darker grey region was associated with the blade undergoing large amplitude inverted-flag type flapping. This blade behavior is associated with an increase in drag. Similar to the blade behavior, the magnitude of drag was also periodic.

It was also observed that during these large amplitude flapping events that the connections between the turbine shaft, torque meter and clamp created a spring-like effect. Along these lines, every time the flapping blade produced substantial amount of force against these connections, they stored the energy. As the flapping blade released the force, the connections discharged the stored energy. This resulted in large amplitude oscillations of the torque data, matching the flapping periodicity of the blade, and resulting in the large variations in amplitude observed in FIG. 19A in the case of the 1/32 inch DELRIN blades (Ca=10). This large amplitude flapping was also observed in the dynamic tests of this blade type—primarily when the turbine had little or no rotational velocity either during startup or under heavy loading.

Also, even though they were not suitable/susceptible to the beneficial flapping in an inverted state, high Cauchy number (Ca>100) blades (e.g., the rubber blades tested) experienced high degrees of blade deformation, creating blades with curvature similar to those seen in a Savonius wind turbine. Thus, they experienced a net positive average torque and may be useful as compared to rigid blade counterparts, perhaps especially as far as avoiding damage in high wind (or other flow) conditions is concerned.

Other unique behavior associated with the testing is noted in the lighter grey regime in FIGS. 18 and 19B. Here, the blades exhibited small amplitude flutter-type oscillations, similar to the flapping of a standard or general flag.

As for the dynamic testing (as suggested in the static testing), it was found that the turbine with rigid blades was unable to sustain rotation, even when no load was applied to the turbine and the turbine was manually started. In contrast, the turbines with flexible blades were able to rotate and produce power.

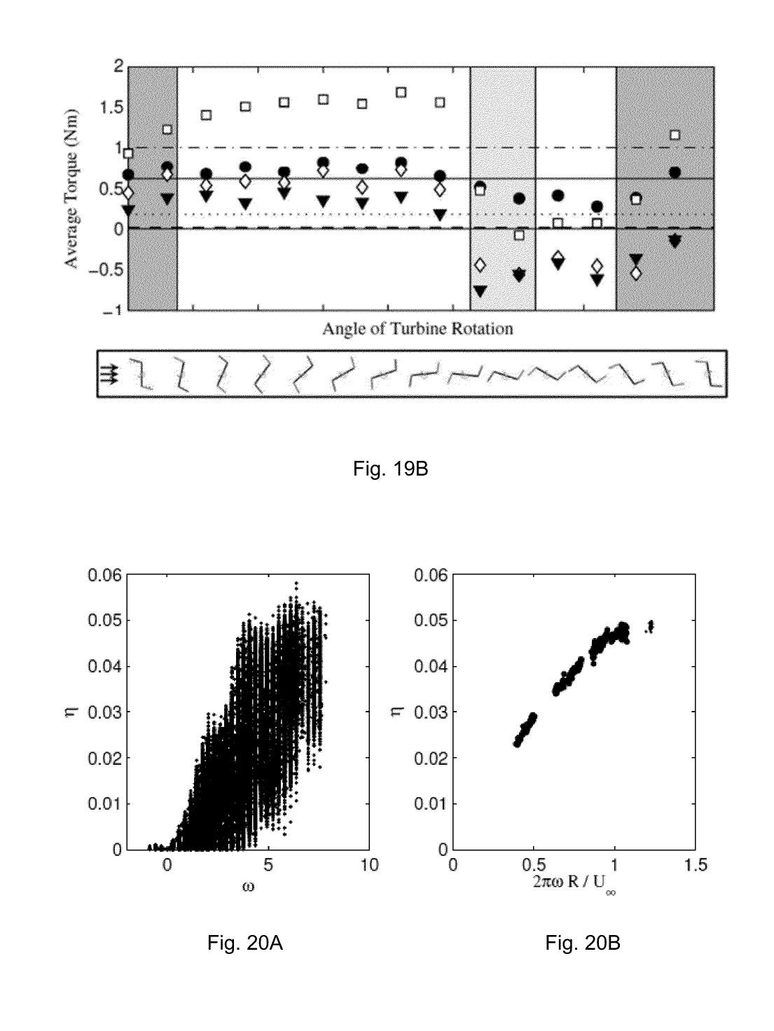

As one example, FIGS. 20A and 20B show the power curve for the turbine setup with 1/32 inch thick DELRIN blades. FIG. 20A shows instantaneous efficiency as a function of angular velocity and FIG. 20B the efficiency for one rotation of the turbine as a function of tip-speed ratio. As such, it is evident that variation in the instantaneous power curve is a result of the unsteady angular velocity throughout one rotation. This variation can be mitigated by methods such as using more than two blades in the turbine configuration or setup.

Also notable, is that unlike other turbines where the power curve cuts off well before the turbine reaches a zero angular velocity, this particular turbine power curve stretches into negative angular velocity. When a sufficiently high load is applied to the turbine, the turbine will start to rotate in reverse. Reverse rotation was observed up until the point that the turbine's position allowed for blade flapping to commence. The turbine would react to the impulsive force resulting from the flapping, and then rotate forwards. Such action clearly demonstrates a self-starting ability unlike any other VAWT. As such, while the regime in which the turbine rotates in reverse does not generate power, test results indicate that it presents a solution to the standard start-up problems of typical VAWT designs. In addition, it is hypothesized that through appropriate blade distribution on a full sized turbine model, that this reverse rotation component can be eliminated.

FIGS. 21A and 21B show power data for two turbine loading conditions (namely 21A had a much higher load applied, and thus higher torque output at a lower rotational speed and 21B has no load—other than internal friction) filtered through a low pass filter to better enable visualizing overall trends. While the main periodicity corresponds to one full turbine rotation, it is interested that there is a local maximum and local minimum in every half period of the power data.

While it was assumed the turbine is symmetric across any vertical plane passing through the rotational axis in the static tests, here it appears that the turbine is not symmetric. However, the dynamics of the system come into play and could also account for the asymmetry observed in the power data. At low loads, the magnitude of this asymmetry (FIG. 21B) is much smaller suggesting that there are slight differences between the two blades of the turbine. As the load is increased on the turbine (FIG. 21A), the asymmetry increases in magnitude dramatically. To understand this behavior it is also important to understand the behavior of the blades. Blade behavior is highly dependent on the relative velocity of the blades. In addition, the blade behavior is directly connected to the extent of the power output.

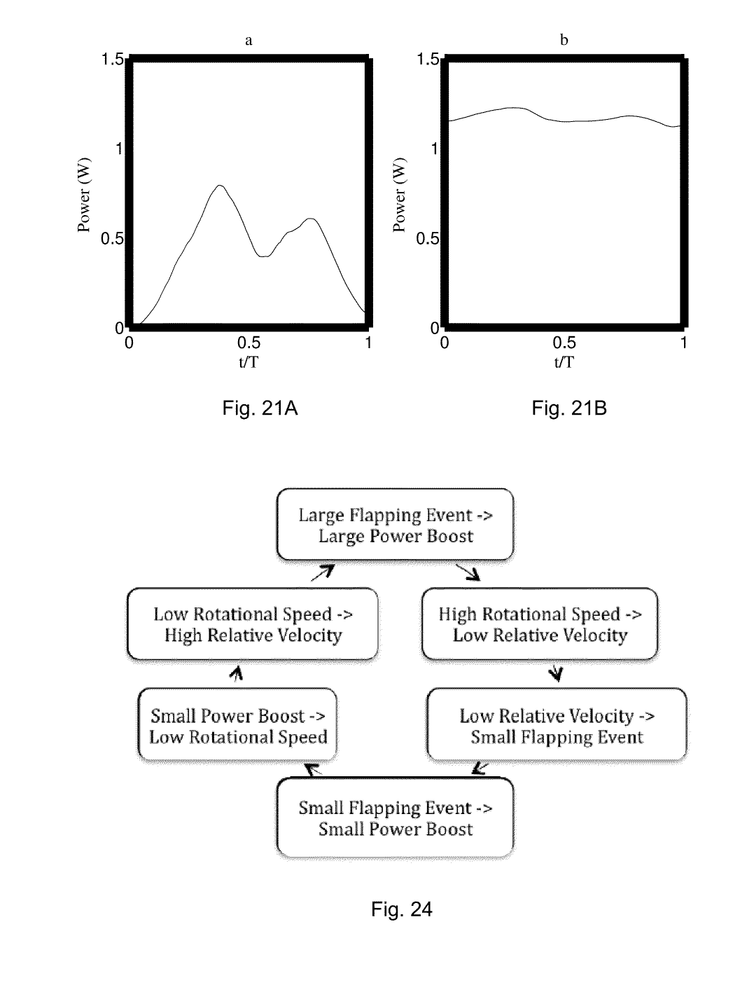

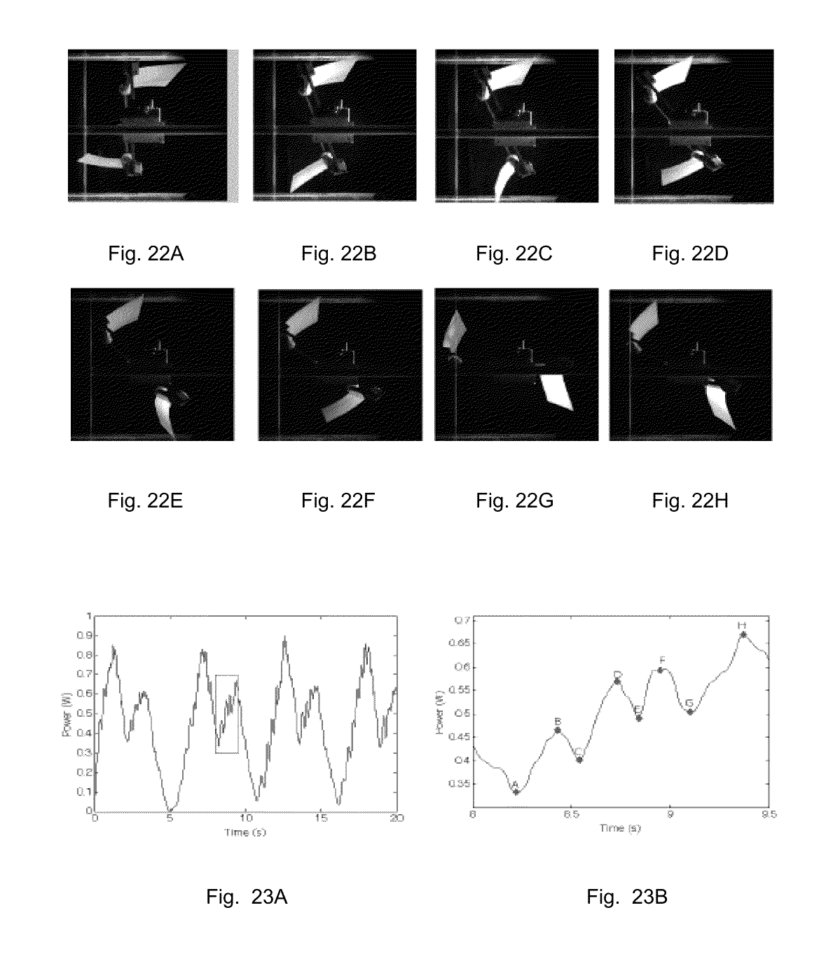

In any case, the impact of the above-referenced flapping behavior on power generation is clearly visible in the power data. Specifically, FIGS. 22A-22H display turbine blade position corresponding to the power output data illustrated in FIGS. 23A and 23B. In the photographs, the wind flow moves from left to right, and the turbine rotates counter-clockwise. The top blade in the images is moving against the wind and will be referred to as the upwind blade, while the blade in the bottom of the picture is moving with the wind and will be referred to as the downwind blade.

As observed, an increase in power follows each flapping event. Power decreases immediately when the front blade of the turbine starts to pass in front of the rear blade. Power increases as the wind “catches” the front blade on its downwind pass. Indeed, through quantitative observation it is apparent that power production is at a minimum just prior to the wind catching the blade. Peak power production ends as the upstream blade passes in front of the downstream blade.

Time point A (pictured in FIG. 22A and indicate in FIG. 23B) corresponds to the point of lowest power production which occurs every half rotation. This occurs just before the downwind blade catches the wind, resulting in the turbine picking up speed and once again producing power. Between time points B and C (each shown in FIGS. 22B and 22C, respectively), the downwind blade is bending away from the wind in a process known as reconfiguration. This leads to a decrease in power output from the turbine. After time point C (FIG. 22C) the blade reverses direction in its flapping, increasing the relative velocity seen by the blade and enhancing power output. This trend happens again with times points D and E (FIGS. 22D and 22E) and once again with time points F and G (FIGS. 22F and 22G). Time point H (FIG. 22H) corresponds to the point where the upwind and downwind blades switch, with the previously upwind blade becoming the downwind blade and thus the power producing blade.

Such large amplitude flapping does not occur at all loading and/or blade cases. Flapping occurs as the loading on the turbine increases and the turbine progresses towards stall. Due to the turbines rotation, the relative wind velocity as seen by the blades is smaller in magnitude that the free stream. Prior to the turbine approaching stall, the relative flow velocity has not yet reached the critical point necessary to excite large scale flapping. However, of the loading cases where flapping is exhibited, the behavior described in the flowchart of FIG. 24 is representative.

As for dynamic startup, this activity was tested using the wind tunnel under conditions starting from rest and quickly moving to a wind tunnel speed of 8.5 ms⁻¹. As the wind velocity increased, the turbine rotated into a position of least resistance—typically with one blade in front of the rear blade. This position is similar to that in FIG. 22G.

In this configuration, the rear blade was seen to start flapping. The flapping propulsion was then sufficient to propel the turbine such that the previously forward blade catches the wind and starts large-amplitude flapping. And as shown under steady operation, this flapping instability produced more rotational motion. As a result, each blade consecutively went through a large scale flapping event, resulting in increased power output until the turbine reached steady state operating conditions.

In addition to the testing above, wind tunnel performance of the blades (of various flexibility) was compared to an analytical model. Existing models provided the theoretical framework to calculate the forces that the subject deformed turbine blades might produce. (See, Frédérick Gosselin, Emmanuel de Langre, B.A.M.A., 2010, “Drag reduction of flexible plates by reconfiguration,” Journal of Fluid Mechanics 650, 1-23; Luhar, M., Nepf, H. M., 2011, “Flow-induced reconfiguration of buoyant and flexible aquatic vegetation,” Journal of Limnology and Oceanography, 2003-2017) where the Euler-Bernoulli beam equation for large deformations,

$$M = EI \frac{\partial φ}{\partial S} , \qquad ( 8 )$$

was worked through in length to yield:

$$EI \frac{{\partial }^{3} φ}{\partial {S}^{3}} = \frac{1}{2} {ρ}_{air} {C}_{D}^{R} {AU}_{∞}^{2} \qquad ( 9 )$$

with drag force as a function of the density of the fluid around the object (ρₐᵢᵣ), the drag coefficient of the rigid blade when perpendicular to the flow (C_{D}^{R}), the cross-sectional area (as seen by the fluid flow), and the velocity of the fluid (U_{∞}) which equation was then non-dimensionalized by introducing dimensionless variables and solved numerically.

However elegant, the model had a number of limitations. First, it only concerned reconfiguration of the blades in the static situation. Second, the model only calculated the drag force and neglected lift created by the turbine blades.

Nevertheless, through use of known geometry, torque on the turbine was calculated and compared to measured quantities. The analytical model was used to predict the forces acting on each individual turbine blade. The balance between the drag force of the two turbine blades was used to predict the drag force and the reconfiguration of the on both turbine blades. Once the drag force had been predicted, the forces are applied to equation (5) to calculate the torque on the turbine at a given statically held position.

The model used model relied on the Cauchy number, a ratio between the inertial and elastic forces experienced by the blades. The exact form of the Cauchy number used was defined as:

$$Ca = \frac{1}{2} \frac{{ρ}_{air} {C}_{D}^{R} {bU}_{∞}^{2} {L}^{3}}{EI} \qquad ( 10 )$$

where I is the area moment of inertia,

$$I = \frac{{bt}^{3}}{12} , \qquad ( 11 )$$

so equation (10) could be rewritten independent of blade height (b), as:

$$Ca = \frac{6 {ρ}_{air} {C}_{D}^{R} {U}_{∞}^{2} {L}^{3}}{{Et}^{3}} . \qquad ( 12 )$$

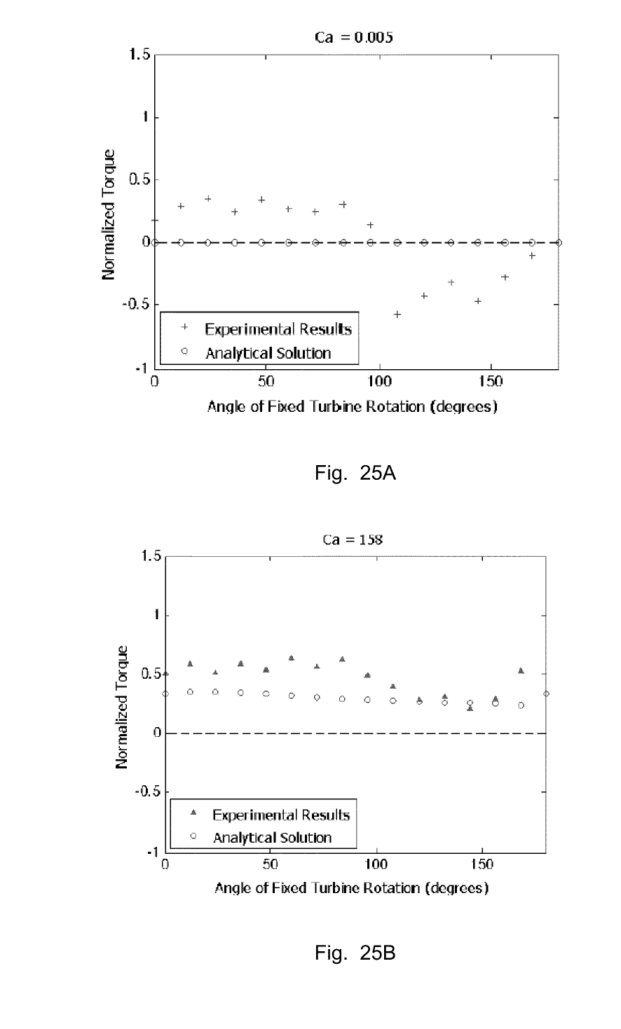

For every static turbine position tested, the torque predicted by the model and the torque recorded through the experiment were compared. These results are plotted in FIG. 25A (rigid aluminum, Ca=0.005) and in FIG. 25B (for rubber, Ca=158).

For the rigid blades (aluminum), the analytical model predicts near zero torque, as would be expected due to the symmetry of the two rigid blades. While the experimental results average to zero net torque, the magnitude of values at every fixed angle was much larger than those predicted by the analytical model as shown in FIG. 25A. This is likely due to lift and blockage effects not considered in the analytical solution.

By contrast, the most compliant blades tested (rubber) demonstrated the greatest agreement between the analytical solution and experimental data as shown in FIG. 25B. This is likely due lack of inverted flag flapping dynamics as previously commented upon—especially demonstrated with the 1/32 inch DELRIN (Ca=10) example—given that the model also omitted such effects.

Table 3 provides further comparison between torque found in testing and the predicted values:

| | | | | Analytically |
|---|---|---|---|---|
| | | | Experimental | Predicated |
| | Thickness | | Average Torque | Average Torque |
| Material | (t) | | (Nm) | (Nm) |
| Aluminum | 0.003175 | m | 0.0173 | 0.00049 |
| | (⅛ | inch) | | |
| DELRIN | 0.0015875 | m | 0.18 | 0.11 |
| | ( 1/16 | inch) | | |
| DELRIN | 0.00079375 | m | 1.0 | 0.80 |
| | ( 1/32 | inch) | | |
| Rubber | 0.003175 | m | 0.62 | 0.3 |
| | (⅛ | inch) | | |

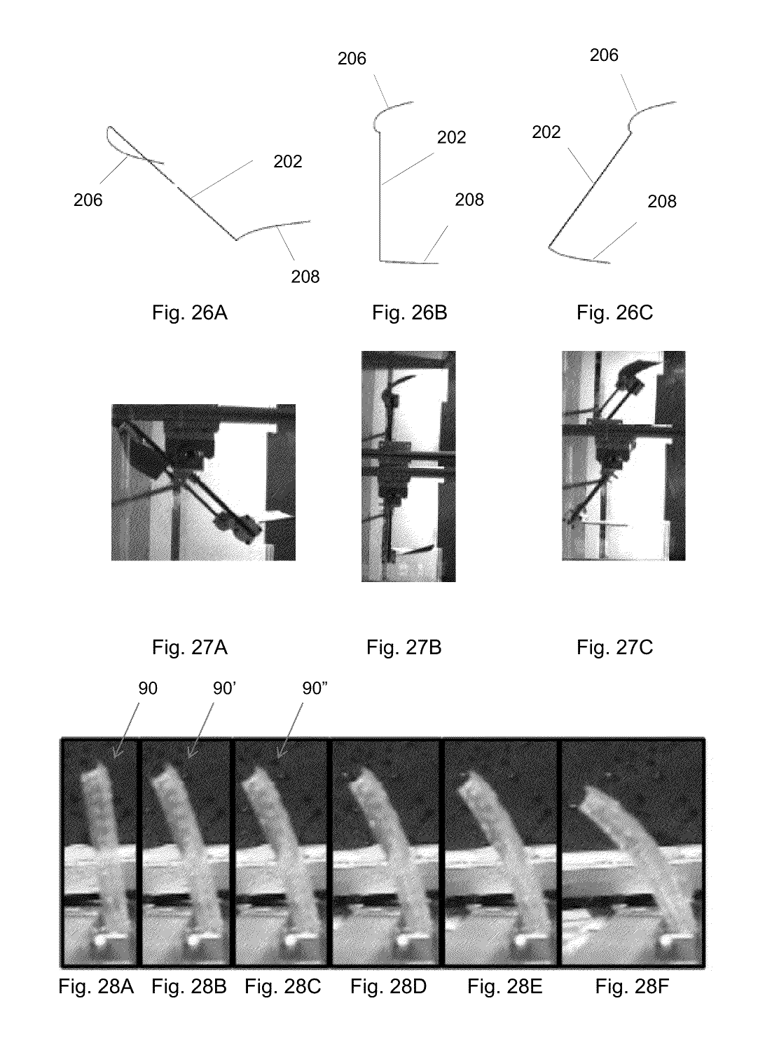

In addition, a graphical representation comparing predicted to actual performance was prepared. FIGS. 26A-26C show predicted states for rubber blades (206, 208) in connection with support arm(s) 202 against corresponding physical structure in FIGS. 27A-27C (static wind tunnel results for rubber blades). Near identical correspondence is shown as would be expected in view of the agreement expressed in the corresponding case represented FIG. 25B.

Overall, a comparison of analytical and test results for the various cases shows that for the regions where drag is the prevailing force, there is very good agreement between the model and test values. Likewise, in areas where one would expect lift to contribute more to the overall turbine performance, there is some discrepancy between the model and the experimental results. As such, use of the model enables isolating lift-based effects of the forces.

Moreover, the test results clearly show that flexible blades can be used to break the symmetry created by the two blades of a VAWT, enhancing positive performance and decreasing negative performance in comparison to a turbine with rigid blades. While current technologies avoid the use of flexible materials due to potentially erratic behaviors, the subject disclosure demonstrates that in some situations these very behaviors can be beneficial to performance. Static tests showed that flexible blades were able to produce rotation where rigid blades would not. Dynamic tests demonstrated enhanced performance with flexible blade flapping and benefits start-up conditions as well.

Pressure Tunable Flag Structures

Hydro-skeleton type structures that maintain their integrity due to an internally pressurized cavity are contemplated for use in the various embodiments described above. Approaches are contemplated to alter shape and/or change material characteristics (e.g. compliance) of their flag-type elements. Hydro-skeleton features can provide a fast-acting approach for quick control over the interactions of a structure with its surroundings.

By controlling flapping flag or wind turbine blade shape, it is possible to change the aerodynamic forces (lift and drag) experienced by the same. Using dissimilar materials around the internal cavity allows the gross shape of the blade to change or morph when the internal cavity is pressurized.

By changing the compliance of a flapping flag or wind turbine blade, it is possible to change how much the body deflects and/or resonates or flaps due to external forces acting thereon. When a compliant structure has an internal cavity, changing the pressure of the internal cavity can modify or otherwise regulate the compliance of the structure (i.e., effectively changing β or Ca). In this situation the cavity does not need to be made of dissimilar materials.

A directionally morphable structure is made with an internal chamber embedded between two materials with dissimilar material properties. This internal chamber can be pressurized, applying a normal force along all of the chamber surfaces. Since the materials are dissimilar, they react differently to the application of the pressure. This allows the construction to bend towards to less elastic material. Stated otherwise, pressurizing the fluid within such a construction causes elastic material containing the fluid to expand or stretch. With different modulus material employed for opposing layers in such a device, a differential in expansion causes the panel to bend away from the more flexible side. The key is a difference in elasticity that changes the effective neutral axis upon pressurization.

Suitable flag-type constructions are pictured in FIGS. 1A and 1B. In each construction, opposite layers 2, 4 may comprise different materials such as ECOFLEX and PDMS (each being a common thermoplastic material) that are heat-bonded together. Various other materials and construction techniques including ultrasonic welding, use of adhesives, rivets, etc. may be employed in construction so long as pressure-tight chamber(s) are formed. As such, in another example, the morphing structures may comprise a metal foil can be used in combination with PDMS or another polymer. Of course, compliance control does not necessitate the use of dissimilar materials in construction.

For either application (compliance and/or shape control) tubes or channels may be produced on the micro-scale (i.e., at the scale of 1 mm, 0.1 mm or less in cross-section diameter) within the device. Accordingly, such “micro-hydraulics” can allow for changing distribution of rigidity as well as shape. Indeed, the inclusion of multiple layers of micro-hydraulics (not show) will allow for shape change in different directions depending on the configuration of tubes in each layer. Alternatively, multiple layers may be used such that one set of chambers or channels is used for energy harvesting and another set is for compliance and/or shape control. For example, one device could be flapping to produce a pressure differential. This pressure then could be used to force shape morphing or modulation of material properties in another blade.

In any case (used in different fashion than described above), a system like that shown in FIG. 2 may be employed for hydraulic control. In which case, with the check valves are omitted from the system, and element 60 may operate as a pump instead of as a generator to control flag shape and/or compliance while flapping. Otherwise pump 60 may operate in connection with feedback control circuitry 66 to moderate pressure in real time to control flag shape and/or compliance simultaneous or in tandem with energy harvesting.

However the approach is implemented, FIGS. 28A-28F demonstrative bending of a flag-type sheet or blade 90 thorough a progression of stages (90′, 90″, etc.) due to internal pressure manipulation. As exemplified by FIGS. 1A and 1B, the flag chambers can have various geometries such as in those including a large reservoir 12 or a tube(s) or channels 22 of various shapes. The shape and location of the chamber can be optimized to improve performance. Internal chamber geometry may be used to define the direction bending will occur and/or compliance is altered. Likewise, configurations can be made with single or multiple chambers (compare FIGS. 1A and 1D). Geometric differences can change the compliance and/or morphing action experienced by the device.

The fluid that fills the chamber can be either liquid or gas. Choice of fluid will depend on the application. Pressurization can be applied rapidly and as a result the shape change can also happen rapidly. Devices can be used in all surrounding media (e.g. air, water, oil, etc.) with the same result of shape change due to the internal pressurization. Especially, by incorporation in the above configurations, the subject hydro-skeleton features can be used to enhance aerodynamic performance.

### VARIATIONS

Methods of using these architectures are also within the scope of this description. The subject methods may variously include assembly and/or installation activities associated with system use and product (e.g., electricity) produced therefrom. Regarding any such methods, these may be carried out in any order of the events which is logically possible, as well as any recited order of events.

Furthermore, where a range of values is provided, it is understood that every intervening value, between the upper and lower limit of that range and any other stated or intervening value in the stated range is encompassed and may be claimed. Likewise, while VAWTs with two blades were discussed above and may be claimed, this number is not exclusive. The subject turbines may include three or more blades. Also, it is contemplated that any optional feature described herein may be set forth and claimed independently, or in combination with any one or more of the features described herein.

Though embodiments have been described in reference to several examples, optionally incorporating various features, the present subject matter is not to be limited to that which is described or indicated as contemplated with respect to each variation. Changes may be made to the variations described and equivalents (whether recited herein or not included for the sake of some brevity) may be substituted without departing from the true spirit and scope of the present subject matter.

Reference to a singular item includes the possibility that there are a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element—-irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the different embodiments or aspects described herein is not to be limited to the examples provided and/or the subject specification, but rather only by the scope of the issued claim language. It should be understood, that the description of specific example embodiments is not intended to limit the scope of the claims to the particular forms disclosed, but on the contrary, this patent is to cover all modifications and equivalents as illustrated, in part, by the appended claims.

1. A power generation apparatus comprising:
a flag comprising at least two opposing layers, the layers connected to one another to form at least one chamber between the layers with an input channel and an output channel; and
at least one check valve fluidly connected to one of the input and output channels.

2. The apparatus of claim 1, comprising two check valves with one connected to each channel.

3. The apparatus of claim 2, wherein the check valves are fluidly connected to a generator.

4. The apparatus of claim 1, further comprising fluid within the chamber and input and output channels.

5. The apparatus of claim 1, wherein the layers comprise thermoplastic polymer and are heat-bonded for connection.

6. The apparatus of claim 5, wherein the input and the output channels are formed between the layers.

7. The apparatus of claim 1, wherein the flag is connected to a mount along an edge.

8. The apparatus of claim 7, wherein the flag is mounted to trail the edge in a standard flag configuration in fluid flow.

9. The apparatus of claim 7, wherein the flag is mounted to lead the edge in an inverted flag configuration in fluid flow.

10. The apparatus of claim 9, wherein the flag is adapted to have a Cauchy number (Ca) of about 9 or above.

11. The apparatus of claim 9, wherein the flag is adapted to have a non-dimensional bending stiffness (β) between about 0.1 and about 0.4.

12. The apparatus of claim 11, wherein β is between about 0.1 and about 0.3.

13. The apparatus of claim 11, wherein β is between about 0.2 and about 0.4.

14. The apparatus of claim 11, wherein β is between about 0.2 and about 0.25.

15. The apparatus of claim 1, wherein the flag is adapted to provide a ratio of peak-to-peak amplitude of maximum deflection to beam length (A/L) of at least about 1.

16. The apparatus of claim 15, wherein A/L is up to about 2.

17. The apparatus of claim 9, wherein the flag is adapted to have a formation number (F) of between about 4.0 and about 6.0.

18. The apparatus of claim 9, wherein the flag is adapted to have a conversion ratio (R) of between about 0.2 and about 0.4.

19. The apparatus of claim 1, comprising an array of the flags.

20. The apparatus of claim 1, wherein the flag is self-supporting in fluid flow.

21. The apparatus of claim 1, wherein the layers are connected around a perimeter of the flag.

22. The apparatus of claim 1, wherein the flag is rectilinear in shape.

23. The apparatus of claim 1, wherein the flag is substantially flat.

24-36. (canceled)
